(19) United States
(12) Patent Application Publication
(10) Pub. No.: US 2013/0158986 A1
(43) Pub. Date: Jun. 20, 2013

(54) COMMUNICATIONS ANALYSIS SYSTEM AND PROCESS

(71) Applicants: Janet Hume Wiles, St Lucia (AU); Andrew Edward Smith, Jindalee (AU); Daniel John Angus, Woolloongabba (AU)

(72) Inventors: Janet Hume Wiles, St Lucia (AU); Andrew Edward Smith, Jindalee (AU); Daniel John Angus, Woolloongabba (AU)

(73) Assignee: THE UNIVERSITY OF QUEENSLAND, St Lucia, Queensland (AU)

(21) Appl. No.: 13/810,447

(22) PCT Filed: Jul. 15, 2011
(86) PCT No.: PCT/AU2011/000898

§ 371 Date: Jan. 15, 2013

(30) Foreign Application Priority Data
Jul. 15, 2010 (AU) 2010903163
Jun. 1, 2011 (AU) 2011902146

(51) Int. Cl. G06F 17/27

(52) U.S. Cl. 704/9

(57) ABSTRACT

A communications analysis process, including: accessing communications data representing communications of processing the communications data to determine similarity data representing similarities between concepts expressed by the one or more persons at different times during said communications; and processing the similarity data to determine one or more metrics of said communications.

### TECHNICAL FIELD

The present invention relates to a system and process for analysing (human) communications of or between one or more persons.

### BACKGROUND

Human communication is an essential tool for sharing a wide range of information between multiple interacting participants. Communication has many genres, including conversation, written exchange, reports, and books. Communication analysis is a field of study that is generally concerned with understanding orderliness, structure and sequential patterns of information, whether in formal or casual communication.

Communication analysis can offer insight into patterns of topic recruitment between communication participants, and analysts have attempted to develop rules or models to explain these patterns. These models or rules can be used to inform participants of their own behaviour, which can be useful if they are undertaking training to improve their communication skills, or to assist in the identification of anomalies or patterns that deviate from a standard model. However, due to its complexity, communication analysis is often performed by hand using manual processes and check-lists, making it a time consuming and at times error-prone process. Existing methods for determining the quality of communications are therefore labour intensive and also require intensive training.

It is desired to provide a communications analysis system and process that alleviate one or more difficulties of the prior art, or at least provide a useful alternative.

### SUMMARY

In accordance with some embodiments of the present invention, there is provided a communications analysis process, including:
accessing communications data representing communications of one or more persons; processing the communications data to determine similarity data representing similarities between concepts expressed by the one or more persons at different times during said communications; and
processing the similarity data to determine one or more metrics of said communications.

The metrics may include metrics for each of one or more selected utterances of said communications.

The processing of the communications data may include:
identifying subsets of said communications as utterances of said one or more persons;
identifying terms of said utterances as representing conceptual content of said communications expressed by said one or more persons;
selecting a subset of said terms as key terms representing respective concepts;
generating numeric measures of the conceptual similarities of the unselected terms to said key terms; and
for each of said utterances, generating a corresponding feature vector including the generated numeric measures of the terms included in the utterance to enable a similarity of any two of said utterances to be determined from the feature vectors for those two utterances.

The conceptual similarity of any two of said utterances may be determined as the dot product of the feature vectors for said two utterances.

The process may include generating concept recurrence data representing a visual representation of said similarities during said human communications. The similarities may be represented as a chart with two axes representing utterances, and the similarity between any two utterances being represented visually at a corresponding coordinates. The similarity may be represented by colour and/or shading. Each utterance may be allocated a fixed size on the axes, or a size representative of the length of the utterance.

The metrics may include a contribution metric representing the number of said concepts of an utterance. The contribution metric may be generated by summing concept scores for the utterance, said concept scores representing similarities of terms in the utterance to said concepts.

In some embodiments, the contribution metric is generated by summing the products of concept scores and transfer functions for the utterance, said concept scores representing similarities of terms in the utterance to said concepts.

The metrics may include an ownership metric representing the degree to which a person owns the content of an utterance. The ownership metric may be generated by subtracting the similarity of the person's utterance and the previous utterance from the similarity of the person's utterance with itself.

The metrics may include an accommodation metric representing the degree to which a speaking person accommodates the immediately previous speaking person's utterance. The accommodation metric may be generated as the similarity of the person's utterance and the previous speaker's utterance.

The metrics may include a leadership metric representing the degree to which a speaking person expressed a new concept that was subsequently repeated by one or more other persons. The leadership metric for an utterance may be generated by summing similarities of the utterance to one or more successive utterances by one or more other persons.

In some embodiments, the leadership metric for an utterance of a person is generated by summing similarities of the utterance to one or more successive utterances by one or more other persons, and then multiplying the sum by an ownership metric for the utterance.

The metrics may include a followership metric representing the degree to which a speaking person repeats the concepts expressed in preceding utterances by one or more other persons within a conversational timeframe. The followership metric for an utterance may be determined by summing the similarities of the utterance with every one or more preceding utterances by other people within a range of utterances from said utterance.

In some embodiments, the followership metric for an utterance is determined by summing the similarities of the utterance with every one or more preceding utterances by other people within a range of utterances from said utterance, and then multiplying the sum by an accommodation metric for the utterance.

The metrics may include an engagement metric representing how well the current utterance engages with concepts suggested by other speakers. The engagement metric for an utterance may be determined by summing the similarities of every preceding and successive utterance by other people within a specified range of utterances from the utterance.

The metrics may include a fixation metric representing the degree to which a person repeats concepts. The fixation metric for an utterance may be generated by summing the similarities of the utterance with every preceding and successive utterance by the same person within a specified range of utterances from the utterance.

The metrics may include an influence metric representing the degree to which the utterance introduces new concepts that are repeated in the future. The influence metric for an utterance may be determined by summing the similarities of the utterance with every preceding utterance by a different person and subtracting this sum from the summed similarities of the utterance with every subsequent utterance by a different person within a specified range of utterances from the utterance.

The metrics may include a conformity metric representing the degree to which an utterance repeats previously and subsequently expressed concepts. The conformity metric may be determined by summing the similarities of the utterance with every preceding and subsequent utterance by a different person within a specified range of utterances from the utterance.

The metrics may include a repetition metric representing the degree to which a person repeats their own concepts. The repetition metric may be determined by summing the similarities of the utterance with every preceding and subsequent utterance by the same person within a specified range of utterances from the utterance.

In some embodiments, the process includes generating values of a plurality of metric primitives for each of said utterances of a corresponding person by summing the similarities of the utterance with one or more selected others of said utterances, said others for each of said metric primitives being selected as a corresponding unique combination of values specifying: (i) the range of utterances from the utterance within which other utterances can be selected; (ii) whether only other utterances following or only other utterances preceding the utterance can be selected; and (iii) whether only the person's own utterances can be selected or only utterances by others can be selected.

In some embodiments, the process includes generating behavioural metrics for one or more of said utterances by combining values of selected ones of the metric primitives.

In some embodiments, the process includes:
generating normalised values of said metric primitives; and
generating behavioural metrics for one or more of said utterances by combining values of selected ones of the normalised metric primitives.

In some embodiments, the process includes generating concept recurrence data representing a visual representation of said similarities during said human communications, including a chart with two axes representing utterances, and the similarity between any two utterances being represented visually at corresponding coordinates.

In some embodiments, the similarity between any two utterances is represented visually by colour and/or shading.

In some embodiments, each utterance is represented by a corresponding dimension representative of the length of the utterance.

In accordance with some embodiments of the present invention, there is provided a computer-readable storage medium having stored thereon programming instructions configured to cause at least one processor executing the stored programming instructions to execute any of the above processes.

In accordance with some embodiments of the present invention, there is provided a communications analysis system configured to execute any of the above processes.

In accordance with some embodiments of the present invention, there is provided a communications analysis system, including one or more communications analysis components configured to execute any of the above processes.

In accordance with some embodiments of the present invention, there is provided a communications analysis system, including one or more communications analysis components configured to:
access communications data representing communications of one or more persons;
process the communications data to determine similarity data representing similarities between concepts expressed by the one or more persons at different times during said communications; and
process the similarity data to determine one or more metrics of said communications.

### BRIEF DESCRIPTION OF THE DRAWINGS

Embodiments of the present invention are hereinafter described, by way of example only, with reference to the accompanying drawings, wherein:

FIG. 1 is a flow diagram of an embodiment of a communications analysis process;

FIG. 2 is a block diagram of an embodiment of a communications analysis system to execute the communications analysis process;

FIG. 3 is a schematic diagram representing the division of input text data into utterances, the generation of a semantic model based on co-occurrences of terms in different utterances, and the use of the semantic model to generate feature vectors;

FIG. 4 is a schematic diagram representing the division of input text data into utterances or other groupings for the purpose of determining conceptual similarities between those utterances or other groupings, and the visualisation of those similarities as a two-dimensional conceptual recurrence plot;

FIGS. 5 and 6 are ‘spider plots’ or ‘radar charts’ showing values of twelve metric primitives generated for (i) control subjects and (ii) subjects with high-functioning autism, respectively;

FIG. 7 includes conceptual recurrence plots and term recurrence plots for the television program Insight;

FIG. 8 includes unannotated (a) and annotated (b), (c), and (d) versions of a conceptual recurrence plot representing a conversation between Andrew Denton and Peter Singer on the Enough Rope television program;

FIG. 9 includes conceptual recurrence plots representing a conversation between Andrew Denton and Jeff Kennett on the Enough Rope television program: (a) the unannotated conceptual recurrence plot, (b) with annotation, (c) and (d): conceptual recurrence plots generated using only the key terms “depression” and “politics”, respectively;

FIG. 10 includes graphs of the long-backward-other (LBO) metric primitive representing backward recurrence during the course of the Denton-Kennett interview, for utterances by Denton (upper graph) and Kennett (lower graph), together with mean expected backward recurrence;

FIG. 11 includes graphs of the long-forward-other (LFO) metric primitive representing forward recurrence during the course of the Denton-Kennett interview, for utterances by Denton (upper graph) and Kennett (lower graph), together with mean expected forward recurrence;

FIG. 12 includes two graphs, each of which graphs: (i) the sum of the medium-forward-other and medium-backward-other metric primitives (i.e., MFO+MBO) and (ii) the sum of the medium-forward-self and medium-backward-self metric primitives (i.e., MFS+MBS), for utterances by Denton (upper graph) and Kennett (lower graph), together with mean expected forward recurrence;

FIG. 13 is a graph showing communication analysis metrics generated by the process for a dataset incorporating every US Presidential inauguration speech;

FIG. 14 is a set of six graphs of respective communication analysis metrics for a professional interview considered to be a good interview;

FIG. 15 is the same as FIG. 9, but for a professional interview considered to be a bad interview;

FIG. 16 includes graphs of global engagement (engagement values for each individual utterance; upper graph), as well as the captain's leadership and followership scores for his individual utterances (lower graph) for a transcript of cockpit and ground communications prior to the crash of United Airlines flight 232 on Jul. 19, 1989;

FIG. 17 is an influence graph that connects each participant of the United Airlines flight according to their influence within the conversation; and

FIG. 18 is a graph of the summed totals for each of 6 metrics for a subset of participants from the United Airlines flight transcript.

### DETAILED DESCRIPTION

The inventors have identified a need for a series of indicators that leverage the conceptual content of human communications, that are quick to obtain, and conceptually simple to understand and interpret. Such indicators would include communications metrics that constitute robust, statistically significant measures to assess a variety of characteristics of human communication, including the degree of engagement between communication participants, the degree of ownership of topics/concepts, and topic longevity, among others.

Additionally, a key to understanding the effectiveness of communication is in understanding the temporal dynamics of that communication, and therefore a communication specific conceptual charting and analysis tool would be of great benefit in communications analysis.

If communication between multiple people is considered as each person navigating an individual conceptual trajectory, then these trajectories can sometimes overlap when the conversants mention the same subject, and can diverge when someone introduces a new topic into the communication narrative. These trajectories can be considered to have a spatial component (the conceptual content) and a temporal component (when a concept is introduced).

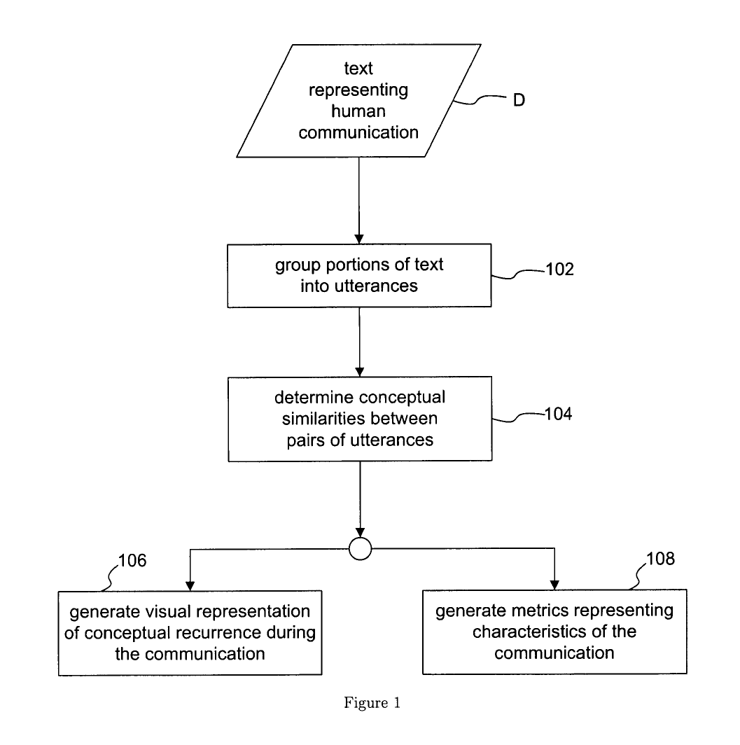

A communications analysis system executes a communications analysis process, as shown in FIG. 1, that analyses human communication of one or more persons or between multiple persons to determine conceptual similarities between pairs of utterances or other portions of the communication. These conceptual similarities can then be used to generate a visual representation of conceptual recurrence during the communication, and/or to generate one or more numeric metrics of the communication. The communications analysis system and processes described herein thus provide communication analysts with powerful new tools for the analysis of human communications.

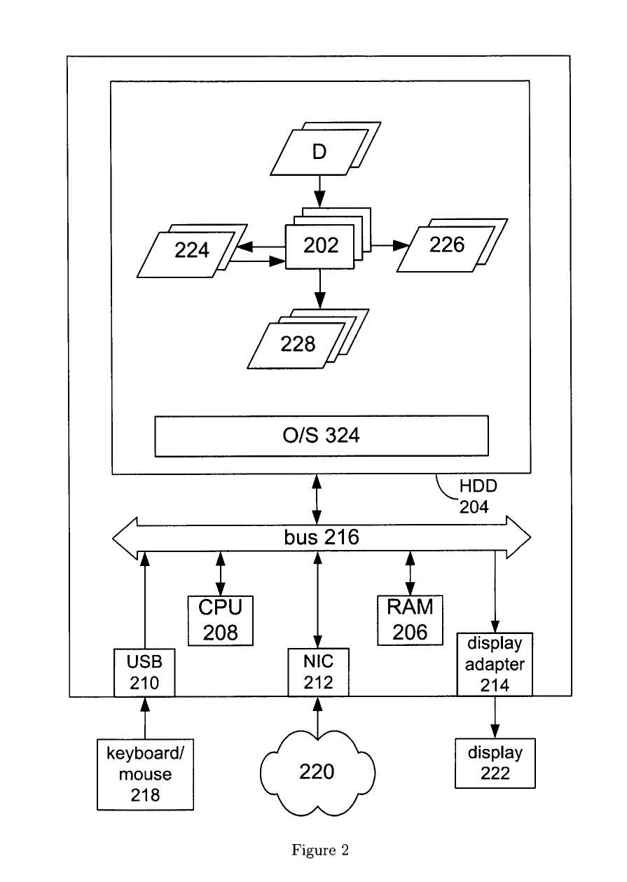

In the described embodiments, the communications analysis system is a standard computer system such as an Intel IA-32 or IA-64 based computer system, as shown in FIG. 2, and the communications analysis processes executed by the system are provided in the form of programming instructions, in executable, interpretable, and/or compilable form, of one or more software modules 202 stored on non-volatile (e.g., hard disk or solid-state drive) storage 204 associated with the computer system, as shown in FIG. 2. However, it will be apparent to those skilled in the art that at least parts of the communications analysis processes could alternatively be implemented as one or more dedicated hardware components, such as application-specific integrated circuits (ASICs) and/or field programmable gate arrays (FPGAs), for example.

The system 200 includes standard computer components, including random access memory (RAM) 206, at least one processor 208, and external interfaces 210, 212, 214, all interconnected by a bus 216. The external interfaces include universal serial bus (USB) interfaces 210, at least one of which is connected to a keyboard 218 and a pointing device such as a mouse 219, a network interface connector (NIC) 212 which connects the system 200 to a communications network such as the Internet 220, and a display adapter 214, which is connected to a display device such as an LCD panel display 222. The system 200 also includes a number of standard software modules, including an operating system 224 such as Linux or Microsoft Windows.

### Conceptual Similarity

Embodiments of the present invention are based on the ability to determine a measure of the conceptual similarity of portions of human communications. In the described embodiments, the communications are input to the system in the form of electronically parseable text data. However, it will be apparent to those skilled in the art that the system could be used to process voice data representing spoken language by including a natural language speech recognition engine to translate the voice data into text form. Suitable speech recognition engines are commercially available from a variety of different vendors. The translation could be performed offline or in real-time.

In any case, the text data is processed to generate a semantic model that can be used to compare any two sections of the text (e.g., any two utterances) for conceptual similarity. In general, conceptual similarity can be determined using any method capable of determine a measure of conceptual similarity between two items of text, including but not limited to
(i) Leximancer™, as described in A. E. Smith and M. S. Humphreys, in Evaluation of unsupervised semantic mapping of natural language with leximancer concept mapping, in Behavior Research Methods, 38(2):262-279, 2006;
(ii) Latent Semantic Analysis, as described in T. Landauer, P. Foltz, and D. Laham, Introduction to latent semantic analysis, in Discourse Processes, 25:259-284, 1998; and
(iii) Latent Dirichlet Allocation, as described in David M Blei, Andrew Y Ng, and Michael I Jordan, Latent dirichlet allocation, Journal of Machine Learning Research, 3:993-1022, 2003.

However, for the sake of clarity, the described embodiment uses a process based on the work of Salton, as described in G. Salton, Automatic text processing: the transformation, analysis, and retrieval of information by computer, Addison-Wesley, 1989. This process uses lexical statistics including term co-occurrence and term occurrence to generate a semantic model, as follows.

An input text document, D, is first processed to remove stop words and all punctuation, while preserving sentence boundaries. The resulting document, D′, is then used to generate a vector of all unique terms referred to herein as the term list, T, which has length Tₘ. An occurrence vector that contains the total number of occurrences, Oₜ_{ᵢ}, of each individual term, tᵢ, is generated. Finally, a co-occurrence matrix, C, is constructed, whose elements, cₜ_{ᵢ}ₜ_{ⱼ} are the co-occurrence values that indicate how many times any pair of terms (tᵢ, tⱼ) co-occur in a finite number≧1 of sentences referred to as the sentence window. For term-term co-occurrence calculation, repeated terms within a sentence window are treated as only appearing once within that particular set of sentences. Through the use of term occurrence and co-occurrence information, the similarity S(tᵢ, tⱼ) of term tᵢ to tⱼ is determined according to a semantic similarity model described at page 275 of Salton, as follows:

$$\begin{matrix}S ( {t}_{i} , {t}_{j} ) = \frac{P ( {t}_{i} , {t}_{j} ) \times P ( {\overline{t}}_{i} , {\overline{t}}_{j} )}{P ( {\overline{t}}_{i} , {t}_{j} ) \times P ( {t}_{i} , {\overline{t}}_{j} )} \\ = \frac{{C}_{{t}_{i} {t}_{j}} \times ( N - {O}_{{t}_{i}} - {O}_{{t}_{j}} + {C}_{{t}_{i} {t}_{j}} )}{( {O}_{{t}_{i}} - {C}_{{t}_{i} {t}_{j}} ) \times ( {O}_{{t}_{j}} - {C}_{{t}_{i} {t}_{j}} )}\end{matrix} \qquad ( 1 )$$

where N is the number of sentences, Oₜ_{ᵢ} is the occurrence of tᵢ, and cₜ_{ᵢ}ₜ_{ⱼ} is the co-occurrence of terms tᵢ and tⱼ.

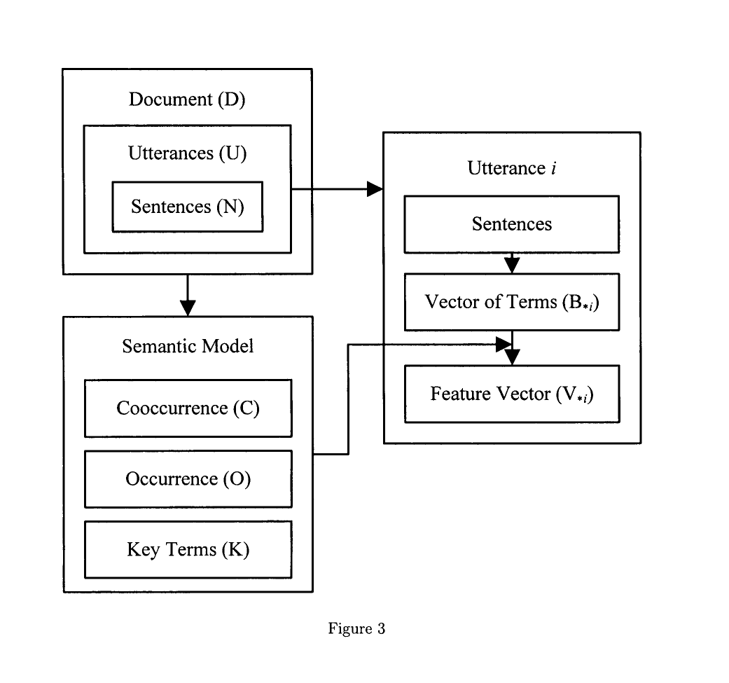

As shown in FIG. 1, at step 102 the sentences in the processed document D′ are organised into groups of one or more sentences referred to herein as utterances U, as shown in FIG. 3, where an utterance can range in size from a single sentence to many sentences, and sentences have membership of only one utterance. The total number of utterances is Uₚ.

The organisation of sentences into utterances is domain specific, and for conversation text, sentences within contiguous blocks of speech by a single user are assigned together into single utterances. For conversation text, each utterance's speaker is recorded in an agent list A, where each entry in A corresponds to an utterance in U. The length of A is thus the same as the length of U. If the text is a single author text, for example a report, paragraph boundaries can be used to define finite utterances rather than speaker turns. As an example, the following text would be broken into four separate utterances as the two speakers each take two turns to speak. In this example, the stop words and speaker names have been left to show the original text structure, but would not be included when measuring semantic similarity, those words remaining being indicated in bold.
1. Jane: Hi Joe how are you feeling today?
2. Joe: Better than I was yesterday thanks Jane. Any idea when I'll be able to get home?
3. Jane: We've got a few more tests to run. Hopefully we'll be getting you out of here in the next day or two.
4. Joe: OK.

As time series data has an implicit ordering (but no other timing information), each utterance is numbered in the order that it is spoken, as indicated in the example above. However, where timing information is available, it can be used as additional meta-data for each utterance an can be used for generating a recurrence plot or graph, as described below, and can allow for the introduction of blanks for periods of silence, and block sizes proportional to the actual time spent talking. In the absence of timing information, block size can be set proportional to the number of terms in the utterance (excluding stop words as they are removed), or it can be left uniform for all utterances. For this example, the agent list (A) would appear as: {Jane, Joe, Jane, Joe}.

At step 104, the conceptual similarities of pairs of utterances is determined as follows. First, as shown in FIG. 3, a list of the most frequent (or “key”) terms, K, is generated by selecting a subset of Kₙ terms with the highest frequencies of occurrence from the term list T. The number of terms to use in constructing K is a function of the vocabulary size. For a document containing 3000 words, where word frequencies follow a Zipf law distribution, Kₙ=30 is sufficient. After constructing K, a matrix of similarity, S, is constructed such that each element of S contains the similarity of a key term to a term in the term list (similar to a concept/term matrix). Thus S has dimension Kₙ×Tₘ. The document D′ is then represented as a Boolean matrix, B, which indicates the presence of individual terms in each utterance (i.e., 1 if a term is present, 0 if the term is not present), such that its dimensionality is Tₘ×Uₚ (similar to a term/document matrix). A feature matrix, V, is then generated as:

V=S×B (2)

so that each column of this matrix (ν*ⱼ) represents the similarity of utterance j to the most frequent terms (K) within document D′. Thus the dimensionality of V is Kₙ×Uₚ (similar to a concept/document matrix).

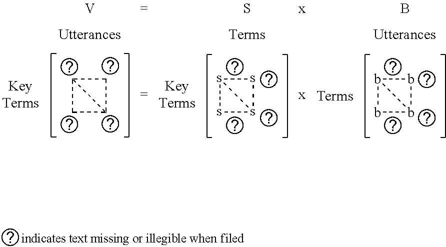

The similarity of any two utterances is then determined as the dot product of the two corresponding columns of V; for example, ν*₁*ν*₂ is a measure of the similarity of utterances 1 and 2. It may be observed that a subset of the matrix elements can be used to obtain a reduced dot product; for example, ν₁₁*ν₁₂ is a measure of the similarity of utterances 1 and 2 using only key term 1.

### Conceptual Recurrence Plot

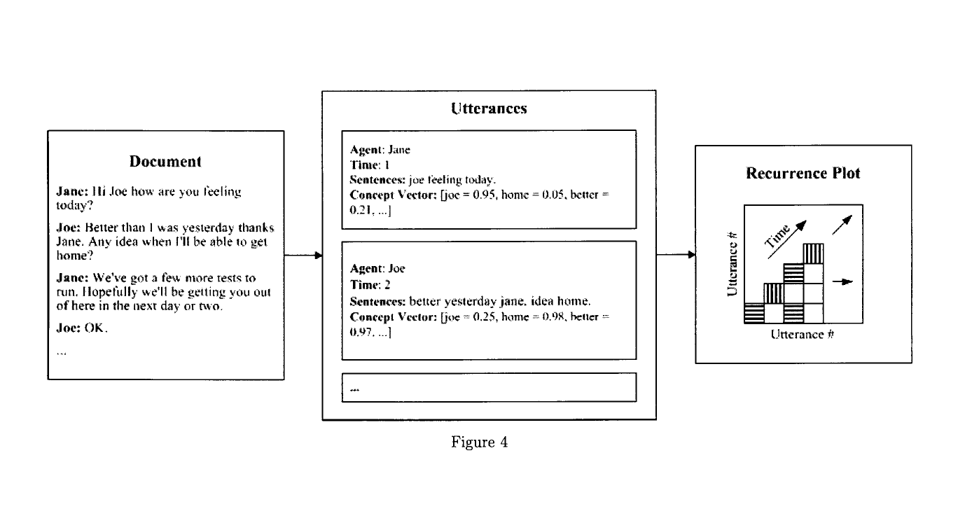

Given a pairwise conceptual similarity measurement, the generation of a concept recurrence plot (or concept recurrence data 226 representing a concept recurrence plot) at step 106 is a straightforward procedure. The conceptual similarity of every utterance to every other utterance is determined as described above, and the results stored in an Uₚ×Uₚ matrix of pairwise conceptual similarity. The comparison can be limited to one side of the diagonal if the comparison is symmetric (as is the case here), otherwise below and above the diagonal can reflect the non-symmetric comparisons. In the described embodiment, the comparisons are symmetric, although it should be understood that this may not be the case in other embodiments. As shown in FIG. 4, the resulting matrix can be displayed by shading each element in the matrix according to its conceptual similarity score (e.g., 1=black, 0=white, with shades of grey between), the resulting diagram or chart being referred to herein as a conceptual recurrence plot. Optionally, these values can be scaled using a non-linear function to emphasize regions of high similarity and de-emphasize regions of low similarity, if desired.

For example, FIG. 4 is a schematic representation of the generation of a conceptual recurrence plot from an input document representing a conversation between two speakers, Jane and Joe. The text of the conversation, in the form of a single document 402, is input into the system and broken into a series of finite utterances 404. These utterances are associated with similarity data that can be used to compare any two utterances for conceptual similarity and thus construct a conceptual recurrence plot 406. In FIG. 4, Jane's utterances are coloured red or shaded with horizontal hatching, Joe's are coloured blue or shaded with vertical hatching. Below the diagonal, grey colour or cross hatching indicates similarity between the two speakers, and the opacity of the shading indicates the degree of match.

Recurrence plots can be enhanced by using different colours or fill patterns for specific speakers, groups, types or other categorisations within a conversation. For example, if a conversation contains two speakers, one can be tagged red and the other tagged blue, or they can be tagged using horizontal, vertical, or diagonal hatching. Each element of the recurrence plot next to the diagonal can be coloured or shaded in the speaker-specific colour or pattern for any element that corresponds to a conceptual comparison between two utterances by this same speaker. If an element corresponds to a conceptual comparison between two different speakers, combinations of shading patterns or colour can be used, as shown in FIG. 4.

### Term-Based Recurrence Plots

Similar to measuring conceptual recurrence, the term-based recurrence of any two utterances can be calculated a number of ways. Term-based recurrence is different to conceptual recurrence as it indicates the degree to which two utterances use the exact same terms, rather than conceptually similar terms, and is described here because it is a useful baseline to compare with conceptual recurrence. One method to calculate term-based recurrence is to take the dot product of any two columns of B; for example, b*ᵢ*b*ⱼ measures the term-wise similarity of utterance i and j. A simplification of this method is to only use the rows of B that correspond to the terms in the Key Term Vector, K, in the calculation. Using this term-based pairwise similarity measurement means that the resulting recurrence plot provides an indication of the number of terms that any pair of utterances share. Similarly to the conceptual recurrence plot, utterances can be coloured or shaded according to the speakers.

### Metrics

At step 108, the similarity values described above can be processed in various ways to generate a set of numeric behavioural metrics 228 that can be used to explain observed behavioural patterns in human communications.

The behavioural metrics 228 are generated from metric primitives (also numeric) that are themselves generated by summing conceptual recurrence values for selected utterances that belong to particular conversation participants, over different time scales.

Specifically, the metric primitives for a specific utterance are generated by summing one or more conceptual recurrence values for the specific utterance and one or more other utterances that are selected according to utterance selection rules defined by the following 3 selection parameters and their associated values:
(i) Time scale:
   Short: only the closest single utterance forward or backward from the current utterance and within a specified range can be selected.
   Medium: only utterances within a specified number of utterances from the current utterance can be selected; the specified ‘medium’ range of utterances is intermediate to the short and long ranges used, and in the described embodiment is set to 10.
   Long: utterances from the entire conversation can be selected.
(ii) Direction:
   Forward: only utterances forward in time from the current utterance can be selected.
   Backward: only utterances backward in time from the current utterance can be selected.
(iii) Type:
   Self: only utterances by the same participant as the current utterance can be selected.
   Other: only utterances by a different participant than the current utterance can be selected.

As described in detail below, these 3 selection parameters and associated values can be combined in various ways to create a set of 3×2×2=12 unique utterance selection rules that define respective metric primitives. The behavioural metrics 228 are then generated by combining the metric primitives in various ways, as described below. It will be apparent that potentially infinite combinations of metric primitives could be defined using basic arithmetic operations. However, described herein are 8 of the possible behavioural metrics generated from the 12 metric primitives.

### Metric Primitives

In the following, μₜ represents the utterance at time t, and A(t) is the conversation agent that owns the utterance at time t.

The 12 metric primitives corresponding to all possible combinations of the metric parameter values described above are described below. For convenience of reference, each metric primitive corresponding to a particular combination of values of the three parameters are referred to in terms of these values and in the order in which the parameters were described above. For example, the first metric primitive described below is for the parameter value combination of (time scale=short, direction=forward, and type=self), and is thus referred to herein as the ‘short-forward-self’, or ‘SFS’ metric primitive.

### Short-Forward-Self

This metric primitive is the similarity of the current speaker's utterance at time t, μₜ, with their own closest occurring utterance forward in time, providing that the closest utterance is within a specified ‘short’ range (within q utterances in the described embodiment) of the current utterance (i.e., at time=t+i, where 1≦i≦q). A reasonable heuristic for this metric primitive is to set q to be equal the number of conversation participants. The short-forward-self primitive is given by:

$$S F S ( t ) = \{ \begin{matrix}Similarity ( {u}_{t} , {u}_{min ( D )} ) & if D \neq 0 \\ 0 & otherwise\end{matrix} \qquad ( 3 )$$

Where min(D) is the smallest index (i) from a candidate set of indices (D) referring to utterances by the same agent within a short range of t:

D={iε[t+1,t+q]:A(t)=A(i)} (4)

### Medium-Forward-Self

This metric primitive is the sum of the similarities of the current speaker's utterance at time t to their own utterances forward in time within a specified ‘medium’ range of utterances from the current utterance. The metric primitive is calculated using values returned from the forward-self-similarity (fss) function. In the described embodiment, the medium range is y=10 utterances; however, it will be apparent that other range values could be used in other embodiments. The medium-forward-self primitive is given by:

$$\begin{matrix}M F S ( t ) = {\sum }_{i = t + 1}^{t + y} fss ( t , i ) & ( 5 ) \\ fss ( t , i ) = \{ \begin{matrix}Similarity ( {u}_{t} , {u}_{i} ) & if A ( t ) = A ( i ) \\ 0 & otherwise\end{matrix} & ( 6 )\end{matrix}$$

### Long-Forward-Self

This metric primitive is the sum of the similarities of the current speaker's utterance at time t to all of their own utterances forward in time up to the limit tₘₐₓ which is the index of the last utterance. This metric primitive is also calculated using values returned from the forward-self-similarity (fss) function defined above. The long-forward-self primitive is given by:

$$L F S ( t ) = {\sum }_{i = t + 1}^{{t}_{max}} fss ( t , i ) \qquad ( 7 )$$

### Short-Backward-Self

This metric primitive is the similarity of the current speaker's utterance at time t to their own closest occurring utterance backward in time, providing that the closest utterance is within the specified ‘short’ range (within w utterances in the described embodiment) of the current utterance (i.e., at time=t−i, where 1≦i≦w). A reasonable heuristic for this metric primitive is to set w to be equal the number of conversation participants. The short-backward-self primitive is given by:

$$S B S ( t ) = \{ \begin{matrix}Similarity ( {u}_{t} , {u}_{max ( G )} ) & if G \neq 0 \\ 0 & otherwise\end{matrix} \qquad ( 8 )$$

Where max(G) is the largest index (i) from a candidate set of indices (G) referring to utterances by the same agent within a short range of t:

G={iε[t−w,t−1]:A(t)=A(i)} (9)

### Medium-Backward-Self

This metric primitive is the sum of the similarities of the current speaker's utterance at time t to their own utterances backward in time within a specified ‘medium’ range of utterances from the current utterance. In the described embodiment, the medium range is y=10 utterances; however, it will be apparent that other range values could be used in other embodiments. The metric primitive is calculated using values returned from the backward-self-similarity (bss) function. The medium-backward-self primitive is given by:

$$\begin{matrix}M B S ( t ) = {\sum }_{i = t - y}^{t - 1} bss ( t , i ) & ( 10 ) \\ bss ( t , i ) = \{ \begin{matrix}Similarity ( {u}_{t} , {u}_{i} ) & if A ( t ) = A ( i ) \\ 0 & otherwise\end{matrix} & ( 11 )\end{matrix}$$

### Long-Backward-Self

This metric primitive is the sum of the similarities of the current speaker's utterance at time t to all of their own utterances backward in time. This metric primitive is also calculated using values returned from the backward-self-similarity (bss) function defined above. The long-backward-self primitive is given by:

$$L B S ( t ) = {\sum }_{i = 1}^{t - 1} bss ( t , i ) \qquad ( 12 )$$

### Short-Forward-Other

This metric primitive is the similarity of the current speaker's utterance at time t to the next utterance, provided that the next utterance is by a different speaker. The short-forward-other primitive is given by:

$$S F O ( t ) = \{ \begin{matrix}Similarity ( {u}_{t} , {u}_{t + 1} ) & if A ( t ) \neq A ( t + 1 ) \\ 0 & otherwise\end{matrix} \qquad ( 13 )$$

### Medium-Forward-Other

This metric primitive is the sum of the similarities of the current speaker's utterance at time t to any utterances by other speakers forward in time within a specified ‘medium’ range of utterances from the current utterance. In the described embodiment, the medium range is y=10 utterances; however, it will be apparent that other range values could be used in other embodiments. The metric primitive is calculated using values returned from the forward-other-similarity (fos) function. The medium-forward-other primitive is given by:

$$\begin{matrix}M F O ( t ) = {\sum }_{i = t + 1}^{t + y} fos ( t , i ) & ( 14 ) \\ fos ( t , i ) = \{ \begin{matrix}Similarity ( {u}_{t} , {u}_{i} ) & if A ( t ) \neq A ( i ) \\ 0 & otherwise\end{matrix} & ( 15 )\end{matrix}$$

### Long-Forward-Other

This metric primitive is the sum of the similarities of the current speaker's utterance at time t to all of their own utterances forward in time up to the limit tₘₐₓ which is the index of the last utterance. This metric primitive is also calculated using values returned from forward-other-similarity (fos) function defined above. The long-forward-other primitive is given by:

$$L F O ( t ) = {\sum }_{i = t + 1}^{{t}_{max}} fos ( t , i ) \qquad ( 16 )$$

### Short-Backward-Other

This metric primitive is the similarity of the current speaker's utterance at time t to the previous utterance, provided that the previous utterance is by a different speaker. The short-backward-other primitive is given by:

$$S F O ( t ) = \{ \begin{matrix}Similarity ( {u}_{t} , {u}_{t - 1} ) & if A ( t ) \neq A ( t - 1 ) \\ 0 & otherwise\end{matrix} \qquad ( 17 )$$

### Medium-Backward-Other

This metric primitive is the sum of the similarities of the current speaker's utterance at time t to any utterances by other speakers backward in time within a specified ‘medium’ range of utterances from the current utterance. In the described embodiment, the medium range is y=10 utterances; however, it will be apparent that other range values could be used in other embodiments. The metric primitive is calculated using values returned from the backward-other-similarity (bos) function. The medium-backward-other primitive is given by:

$$\begin{matrix}M B O ( t ) = {\sum }_{i = t - y}^{t - 1} bos ( t , i ) & ( 18 ) \\ bos ( t , i ) = \{ \begin{matrix}Similarity ( {u}_{t} , {u}_{i} ) & if A ( t ) \neq A ( i ) \\ 0 & otherwise\end{matrix} & ( 19 )\end{matrix}$$

### Long-Backward-Other

This metric primitive is the sum of the similarities of the current speaker's utterance at time t to all previous utterances by other speakers backward in time. This metric primitive is also calculated using values returned from backward-other-similarity (bos) function defined above. The long-backward-other primitive is given by:

$$L B O ( t ) = {\sum }_{i = 1}^{t - 1} bos ( t , i ) \qquad ( 20 )$$

### Metric Primitive Normalisation

For the purposes of metric primitive combination, it is useful although not essential to be able to normalise each metric primitive into the range [0,1]. One method is based on the minimum and maximum possible metric primitive values that can be obtained for each of the 12 metrics. If the similarity scores (conceptual recurrence values) obtained are within the range [0,1], the normalised value of each metric primitive is calculated by dividing the metric primitive by the normalisation factors below:

| Metric Primitive | Normalisation Factor |
|---|---|
| SFS | 1 |
| MFS | count{i ε [t + 1, t + y]:A(t) = A(i)} |
| LFS | count{i ε [t + 1, tₘₐₓ]:A(t) = A(i)} |
| SBS | 1 |
| MBS | count{i ε [t − y, t − 1]:A(t) = A(i)} |
| LBS | count{i ε [1, t − 1]:A(t) = A(i)} |
| SFO | 1 |
| MFO | count{i ε [t + 1, t + y]:A(t) ≠ A(i)} |
| LFO | count{i ε [t + 1, tₘₐₓ]:A(t) ≠ A(i)} |
| SBO | 1 |
| MBO | count{i ε [t − y, t − 1]:A(t) ≠ A(i)} |
| LBO | count{i ε [1, t − 1]:A(t) ≠ A(i)} |

The function “count(x)” returns the total number of indices contained in the specified set x. As an example, the normalised medium-forward-self primitive (MFS′) is given by:

$$M F {S}^{ ′} ( t ) = \frac{M F S ( t )}{count \{ i ∈ [ t + 1 , t + y ] : A ( t ) = A ( i ) \}} \qquad ( 21 )$$

Having defined the 12 metric primitives and corresponding normalisation factors, these can then be combined in various ways to generate the behavioural metrics 228 that provide quantitative measures of the communication behaviour of one or more participants. The ten metrics described below are grounded in observed conversational behaviour and are defined within an appropriate metric-relevant range, as described below.

Any of the metric primitives described can be used in their normalised or non-normalised forms, depending on the context. Best practice in most contexts will be to use the normalised form. A counterexample where un-normalised primitives would be used is in comparison of the same metric between different datasets where differences in the average amount of utterance similarity (recurrence) is the measurement of interest. For simplicity in the following description, the prime has been omitted from the metric primitive symbols in the equations, but the reader should infer the prime and assume that the metric primitives are used in their normalised forms unless circumstance dictates otherwise.

### Intrinsic Metrics

Contribution: A contribution metric measures the conceptual richness of an utterance by quantifying the number of unique concepts that appear in the feature vector for that utterance. In some cases, it may be desirable to modify the contribution of each entry of the feature vector in an utterance by way of a transfer function (ƒ(•)) such as a sigmoid or threshold function. An example function for calculating Contribution is:

$$Contribution ( t ) = {\sum }_{n = 1}^{{K}_{n}} f ( {v}_{nt} ) \qquad ( 22 )$$

Where: Kₙ is the set of key terms selected from the term list, T, and νₙₜ is the concept score of the n^{th} concept for the utterance at time t.

### Short Time Constant Metrics

Short time constant metrics take account of very immediate accommodation behaviour in conversation, between one utterance to the next. There is a strong tendency for participants to immediately indicate comprehension and encouragement, or the opposite, in reply to another person's statement, commonly referred to as back-channeling.

Ownership: An ownership metric represents the degree to which a speaker owns the content of a specific utterance. The current speaker's utterance at time=t is compared to the previous utterance at time=t−1. The resultant recurrence value is subtracted from the self-similarity of the utterance at time=t, which is equal to 1 in cases where the similarity scores (conceptual recurrence values) obtained are within the range [0,1]. A high recurrence with the previous utterance will therefore result in a low degree of ownership.

Ownership(t)=Similarity(uₜ,uₜ)−SBO(t) (23)

Accommodation: An accommodation metric represents the degree to which a speaker accommodates the previous speaker's utterance. This metric is calculated in a similar manner to ownership, however the resultant recurrence value is not subtracted from the self-similarity of the first utterance. It is the opposite of ownership. This metric tries to capture the strong tendency for people to immediately indicate comprehension and encouragement, or the opposite, in response to another person's statement. The metric represents the degree to which a person accommodates the previous person's utterance. The accommodation value is calculated by measuring the similarity of the utterance under study to the previous utterance spoken. A single accommodation value can be calculated for each person by averaging their own accommodation values over the number of utterances that they have spoken.

Accommodation(t)=SBO(t) (24)

### Medium Time Constant Metrics

Medium time constant metrics measure short periods of conversational behaviour. This behaviour is very group oriented, and involves aspects of leadership, respect, approval, and their opposites. The metric-relevant range (y) is selected to reflect the span of shared attention to a topic by a group, and can be measured by finding where the recurrence value drops below a set threshold, or can be set to a predetermined or default value (of y=10 utterances in the described embodiments). For a single focussed conversation group, this may be adequate, but for fragmented forums a more sophisticated measure may be required, for example a running average.

Leadership: A leadership metric for a given utterance t is determined by summing the recurrence of every successive utterance by every other person within the metric-relevant range. This sum is optionally multiplied by the ownership value to attribute leadership scores to the speaker who owns the conceptual content that other speakers have subsequently talked about in the immediate conversation. Simply speaking, the leadership metric represents the degree to which a participant contributed an idea which was not direct repetition, and this idea was subsequently carried along by others in the conversation.

Leadership(t)=MFO(t)×(1−SBO(t)) (25)

Followership: A followership metric for a specific utterance is determined by summing the recurrence of every preceding utterance by other people within the metric-relevant range. Optionally, this sum is multiplied by the accommodation value to attribute followership scores to the speakers who repeat the conceptual content that the immediately prior speaker has talked about.

Followership(t)=MBO(t)×SBO(t) (26)

Engagement: An engagement metric for an utterance is determined by summing the recurrence of every preceding and successive utterance by other people within the metric-relevant range. This value reflects how well the current utterance engages with concepts suggested by other speakers in the immediate temporal vicinity.

Engagement(t)=MBO(t)+MFO(t) (27)

Fixation: A fixation metric for an utterance is determined by summing the recurrence of every preceding and successive utterance by the same person within the metric-relevant range. This metric reflects the degree to which a participant repeats ideas within a conversational time frame. For example, this could be the result of an important question remaining unanswered, or by abnormal conversational behaviour.

Fixation(t)=MBS(t)+MFS(t) (28)

Long Time Constant Metrics

Long time constant metrics measure long periods of conversational behaviour. These metrics capture how a particular utterance or conversational participant can influence or be influenced by topics over an extended period of time, even after the conversation has had numerous topic changes.

Influence: An influence metric for an utterance is determined by summing the recurrence of every preceding utterance by a different person and subtracting this sum from the summed recurrence of every subsequent utterance by a different person within the metric-relevant range. If the metric value is largely positive, this implies that the utterance contains concepts that have recurred strongly in the future; if largely negative, this implies that the utterance borrows concepts from the past that do not recur strongly in the future. This value can be normalised to take into account the bias towards early occurring utterances to be strongly positive and later occurring utterances to be strongly negative.

Influence(t)=LFO(t)−LBO(t) (29)

Conformity: A conformity metric is determined by summing the recurrence of every preceding and subsequent utterance by a different person within the metric-relevant range. High values of conformity indicate that this speaker is reusing concepts (from all time) quite strongly. Lower conformity indicates that an utterance is rather unique. For example, the group conversation could be in transition between two stable topics or states.

Conformity(t)=LFO(t)+LBO(t) (30)

Repetition: A repetition metric is determined by summing the recurrence of every preceding and subsequent utterance by the same person within the metric-relevant range, and is a measure of how often a speaker repeats their own concepts on a longer time scale. This repetition may be deliberate and strategic, or it could be due to a particular speaker becoming fixated on a particular concept, or set of concepts, for a long time.

Repetition(t)=LFS(t)+LBS(t) (31)

### EXAMPLES

### Qualitative Analysis Using Conceptual Recurrence Plots

In this section, the analysis of three datasets is described. The first dataset is used to demonstrate the differences between using conceptual similarity and term-based similarity. The later analyses highlight how major qualitative features can be identified using the recurrence plotting process, how these features can be linked to speaker behaviour, and how recurrence plots can be explored through the isolation of individual key concepts.

### Example 1

### Children with High Functioning Autism

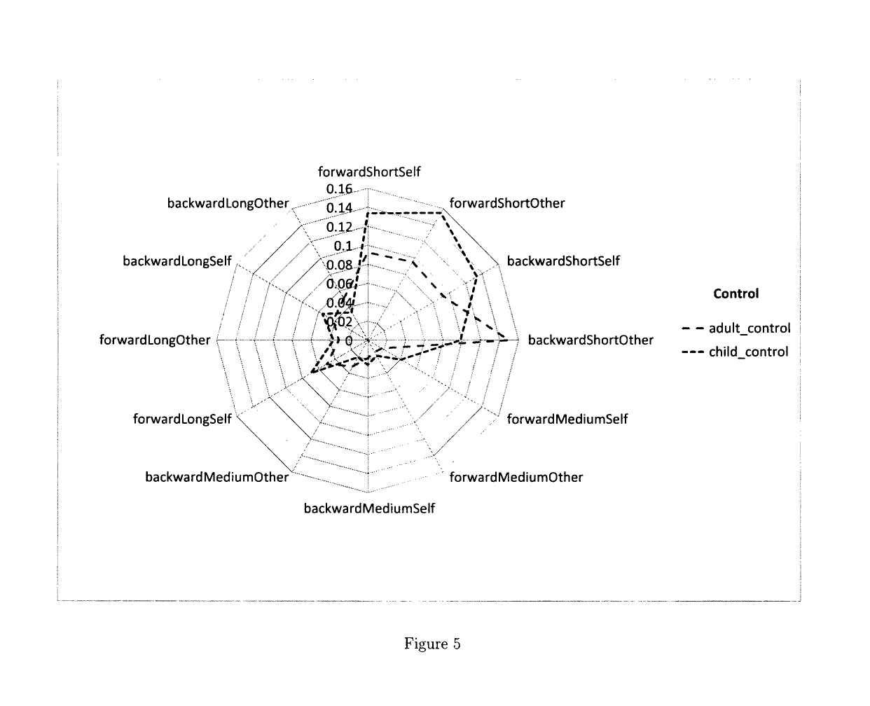

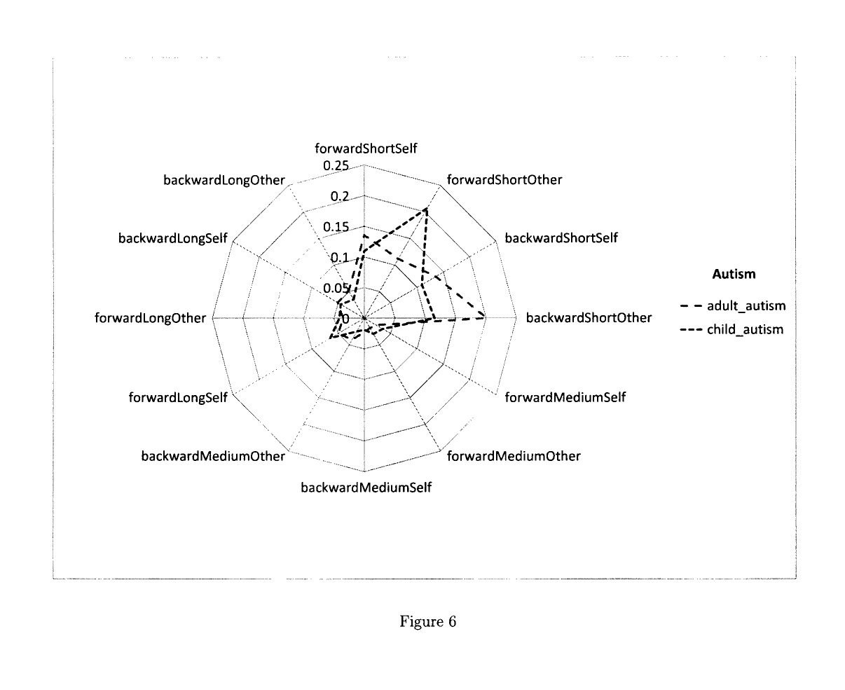

Children with High-Functioning Autism (HFA) produce conversational narratives that differ to those of their typically developing peers. Conceptual recurrent plots and the metric primitives described above can be used to visualize differences between control and test subjects. FIGS. 5 and 6 are ‘spider plots’ or ‘radar charts’ showing values of the twelve metric primitives generated for (i) control subjects and (ii) subjects with high-functioning autism, respectively. Each metric primitive was averaged over time for a single conversation, and the results from each study group were averaged (6 autism datasets, 6 control datasets). Adult and child subjects are shown separately in each plot. Children with HFA produced narratives similar in quantity and topics, but less coherent and elaborated than the control subjects. The metric primitive plots show diminished values for the Forward-Short-Self and Backward-Short-Self values for the children with autism (compared to the control group), which is consistent with the finding that these subjects are less coherent and don't elaborate on their own concepts.

### Example 2

### SBS Insight: Emergency

The first dataset analysed is from the Insight television program (see http://news.sbs.com.au/insight/), a panel discussion program broadcast by an Australian independent national broadcaster, Special Broadcast Services (SBS). Insight consists of an audience of approximately 40 people discussing a controversial topic for one hour. The audience often includes parliamentarians, industry and academic experts, and other members of the public who are in some way affected by the issue being discussed. The program's host Jenny Brockie maintains a position of impartiality to the discussion and acts to steer the discussion to ensure that all sides of an issue are raised. Out-of-turn statements and interjections by audience participants are discouraged, and thus participants' utterances tend to contain many sentences. Brockie's interview style is to ask a question to a particular audience member, then use the response to frame a follow-up question to that same person or another member of the audience. This pattern of interaction allows Brockie to control the debate and enable communication between experts and non-experts. Even though the audience is comprised of around 40 people, the time constraints mean that only about half of the audience contribute to the discussion, with preference given to experts. The specific program used for analysis here is titled Emergency, and is on the topic of hospital emergency departments within Australia, see http://news.sbs.com.au/insight/episode/index/id/112#transcript.

### Aims

The aims of this example are:
(i) to compare conceptual and term-based measures of similarity when used in the creation of recurrence plots; and,
(ii) to compare different methods of plotting a conversation transcript, first using a uniform block size for each utterance, and second using a block-size proportional to the length of the utterance.

### Method

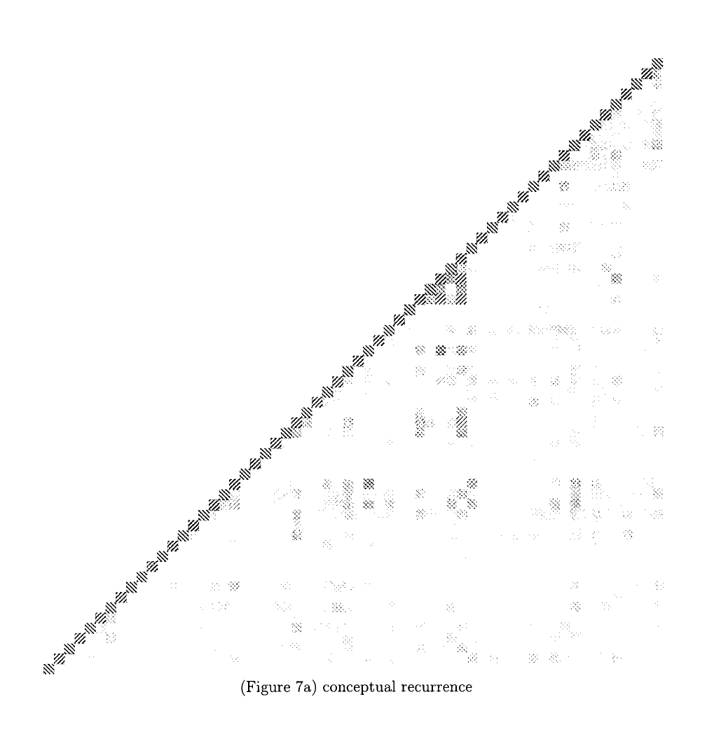

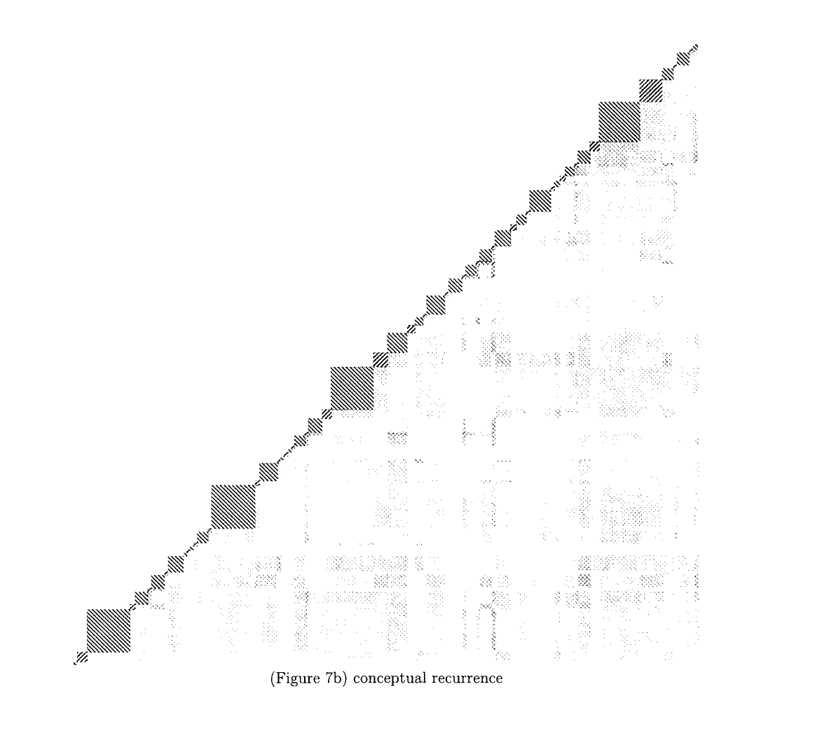

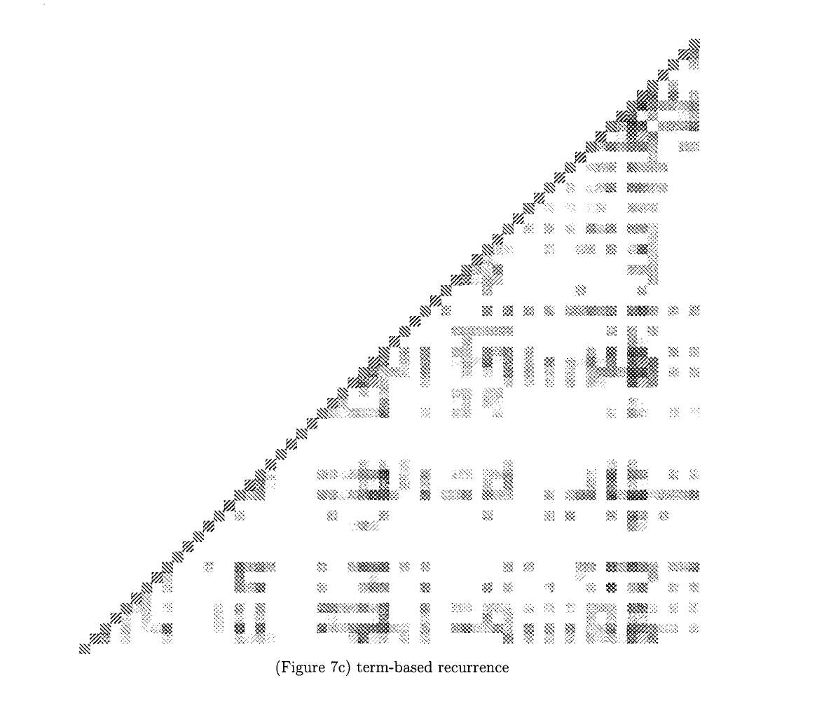

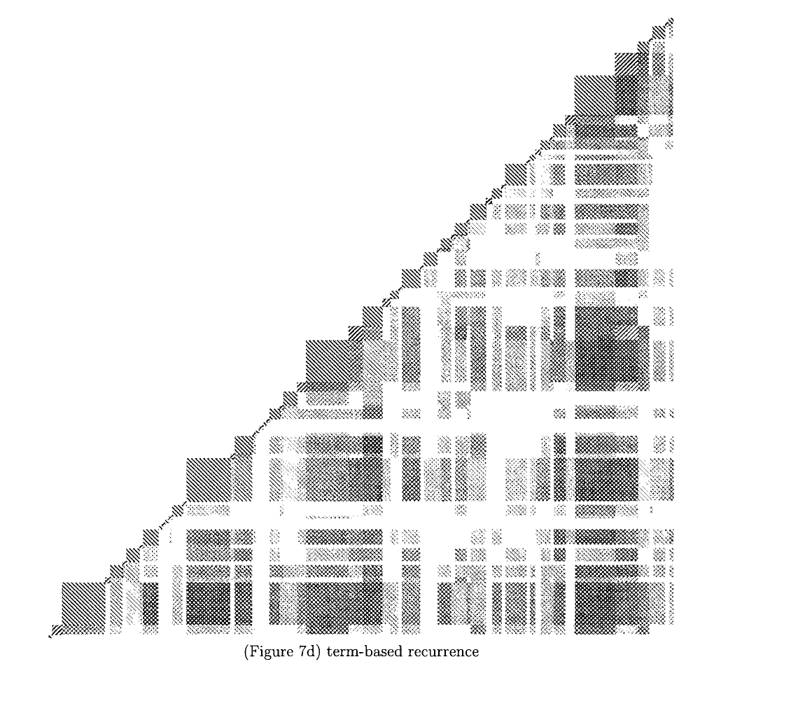

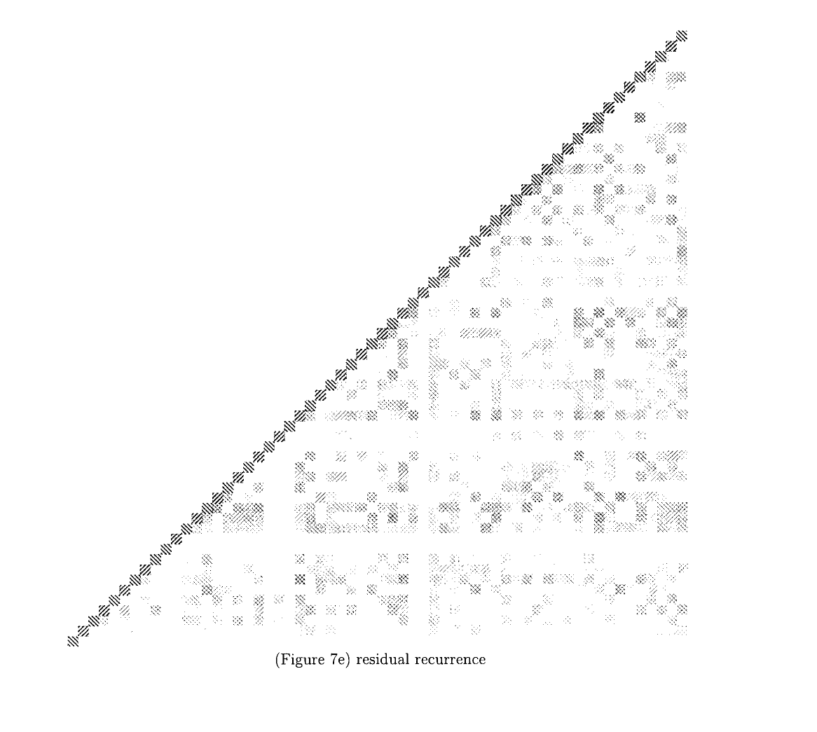

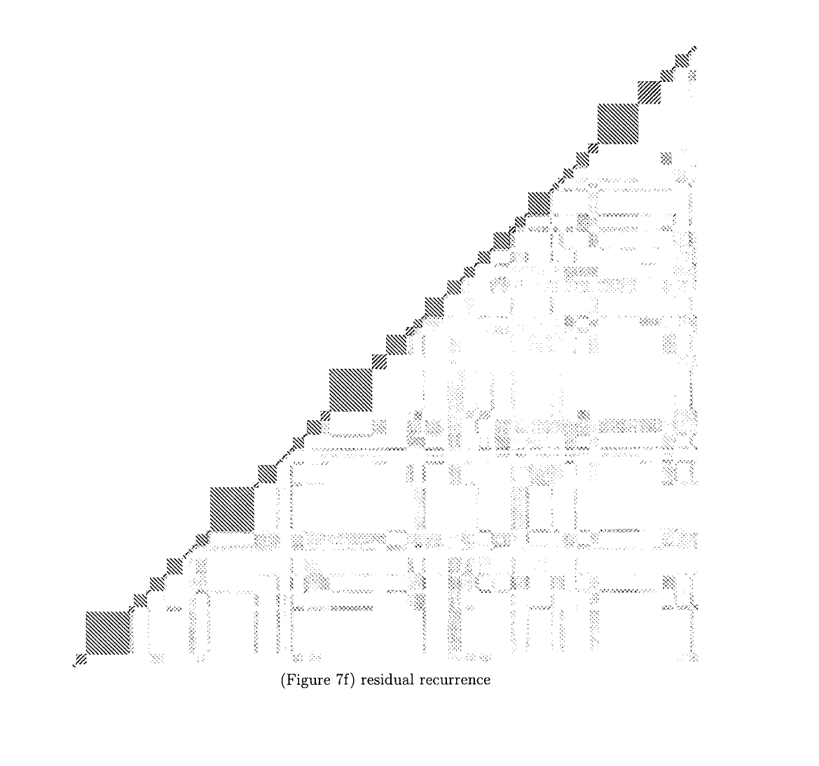

The entire text transcript was used to generate a semantic model and individual utterance feature vectors, as described above. A subset of 60 utterances was used to generate recurrence plots to better highlight the difference between the conceptual and term-based recurrence plots. Plots of conceptual and term-based recurrence are shown in FIG. 7, using uniform block sizing (the left-hand column FIGS. 7a and 7c) and block size proportional to the number of terms in each utterance (the right-hand column FIGS. 7b, and 7d). The magnitude of difference between the amount of conceptual and term-based recurrence is also shown in FIGS. 7e and 7f.

### Results

Conceptual and term-based recurrence plots for the SBS Insight program on hospital emergency rooms are shown in FIGS. 7a to 7d, with the host Jenny Brockie being indicated in red or upward-right diagonal hatching and all audience members being indicated in blue or downward-right diagonal hatching. Recurrences between Brockie and any audience member are represented in green or cross-hatching, and self-recurrence by Brockie is represented in red or upward-right diagonal hatching. Self-recurrence by an individual audience member is represented in blue or downward-right diagonal hatching and recurrence between different audience members is represented in grey or cross-hatching. The left-hand plots (FIGS. 7 a, c, and e) use a uniform utterance size, whereas the plots on the right-hand side (FIGS. 7 b, d, and f) render the utterances according to their actual length. As shown in FIG. 7a, the alternation between red or upward-right diagonal hatching and blue or downward-right diagonal hatching regions along the diagonal reflects the interaction between Brockie and the audience. The predominance of green or cross-hatching off diagonal represents the similarity between Brockie and the audience throughout the conversation.

FIG. 7b shows the same conceptual recurrence as 7a, but rendered using block sizes proportional to the lengths of respective utterances. FIG. 7c uses term-based recurrence instead of conceptual recurrence, and leads to less off-diagonal shading. As shown in FIG. 7d, term-based recurrence tends to occur between larger utterances. The residual recurrence shown in FIGS. 7e and 7f is the difference between the corresponding conceptual and term-based recurrence plots. The majority of the residual is attributed to host Brockie, either between her own utterances, or with other audience members. As shown in FIG. 7f, the residual recurrence is seen to mostly occur on small utterances.

Comparing the conceptual (FIGS. 7a and b) and term-based (FIGS. 7c and d) processes, it is apparent that both techniques succeed in highlighting recurrence between individual conversation participants and Brockie. This finding indicates strong engagement around a topic or set of topics by Brockie and the individual when they are engaged in a back-and-forth exchange.

Engagement is further highlighted by strong recurrence within small blocks along the diagonal (engagement blocks). In the term-based recurrence plots (FIGS. 7c and 7d), several bands of white space punctuate these small periods of strong engagement. These white spaces are not present to the same degree in the conceptual recurrence plots (FIGS. 7a and 7b). An explanation for this difference is that the specific terms being used by Brockie when she is reframing a question are different to those used by the individuals, however Brockie is still using the same conceptual information.

Given the large amount of extra recurrence attributed to Brockie when contrasting between the term-based and conceptual recurrence plots, it can be concluded that Brockie is performing the role of a global communication channel in some instances. Brockie is effectively creating a general language that viewers at home and other members of the audience can follow without using speaker-specific terms and instances, providing a summary of what they have said before readdressing the topic to someone else. This means that many of her utterances have low term-based similarity, yet high conceptual similarity. A numerical analysis of the distribution of recurrence in the term-based recurrence plot and the conceptual recurrence plot supports this conclusion, given that comparisons of the conceptual and term-based recurrence plots indicated a 10% increase in the amount of recurrence attributed to Brockie's own utterances, and a 5% increase in the amount of recurrence between Brockie and other speakers. The total amount of recurrence was calculated by summing the off-diagonal elements of the recurrence matrices. The percentage difference would increase even more in more heterogeneous data sets where there is more diversity of vocabulary.

### Example 3

### Denton/Singer Interview

### Data

The second and third datasets are from the long running Australian television series Enough Rope (see http://www.abc.net.au/tv/enoughrope), produced by Zapruder's Other Films Pty. Ltd., and broadcast by the publicly funded Australian Broadcasting Corporation (ABC). The program is hosted by Andrew Denton and consists of the host interviewing prominent celebrities, including influential musicians, politicians, authors, actors and members of the public who may have an interesting life story to tell. Denton's style of interviewing can be somewhat confrontational, and he often manages to get his interviewees to divulge opinions on controversial issues and details of their personal life.

The show's format comprises Denton and the interviewee sitting on a stage in front of a live studio audience, on chairs that are placed opposite each other and tilted inwards. The stage is set to take focus off the camera and audience, and thereby allow for a more natural conversation between Denton and the interviewee. The interviews are interesting as texts for analysing conversation, as there are often points when Denton gets interviewees discussing topics that they would not normally share openly. It is also interesting as many interviewees are aware of topics that they don't want to talk about, and try to avoid questions, sometimes becoming openly aggressive or defensive.

The interview analysed here is with ethicist and animal rights campaigner Professor Peter Singer (see http://www.abc.net.au/tv/enoughrope/transcripts/s1213309.htm). This particular dataset was chosen due to the richness of the discussion by Singer and Denton, and because the interview was characterised into several stanzas centred on different ethical issues including: food choices, abortion, personal choice, and sexuality.

### Aims

By adapting the idea of characteristic features of recurrence plots to conversation behaviour, the aim is to see how characteristic features can aid in the interpretation of conceptual recurrence plots. The features identified include:
(i) Random Scattering: stochastic/chance conceptual similarity.
(ii) Horizontal/Vertical Lines: one single utterance having conceptual similarity to multiple other utterances separated in time.
(iii) Bands of White Space: transients, utterances containing concepts that are not present anywhere else.
(iv) Upward Diagonals: concept repetition connected in time.
(v) Non-uniform Texture Outward from Diagonal (dark to light): drift in the system, conceptual progression over time.

### Method

The entire text transcript of the Denton/Singer interview was used to create a semantic model and conceptual recurrence plot. The resultant plot was inspected manually to identify characteristic features and these features were annotated onto the recurrence plots.

### Results

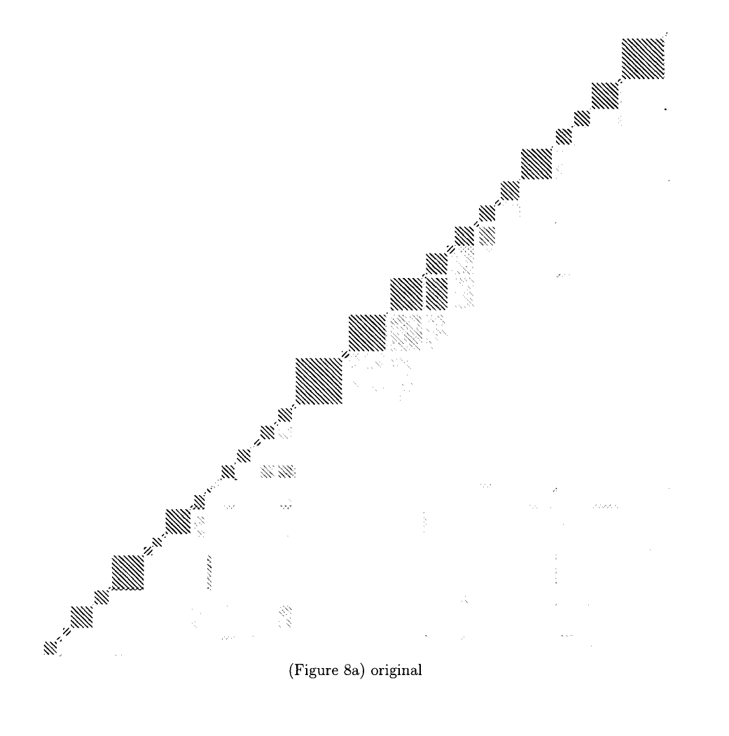

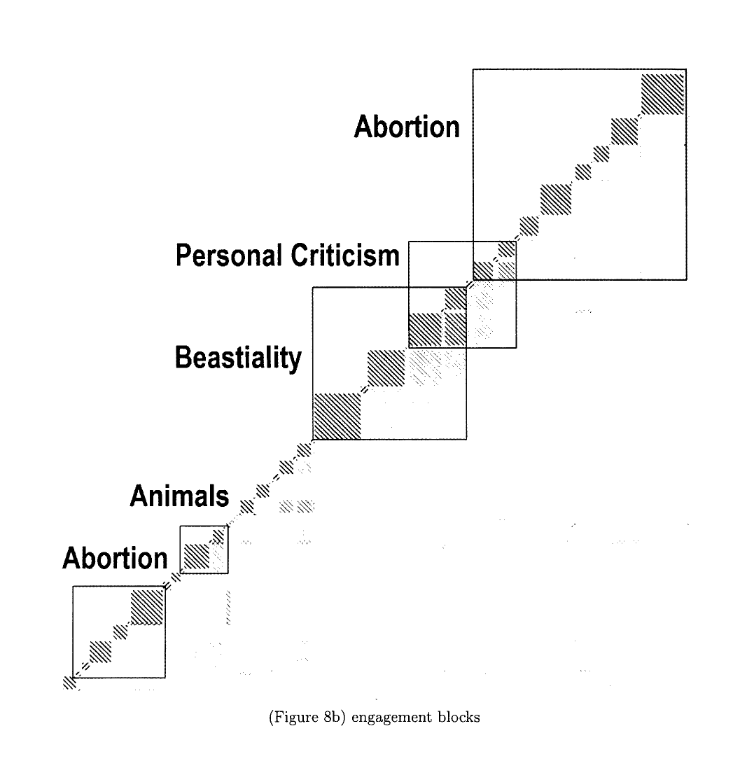

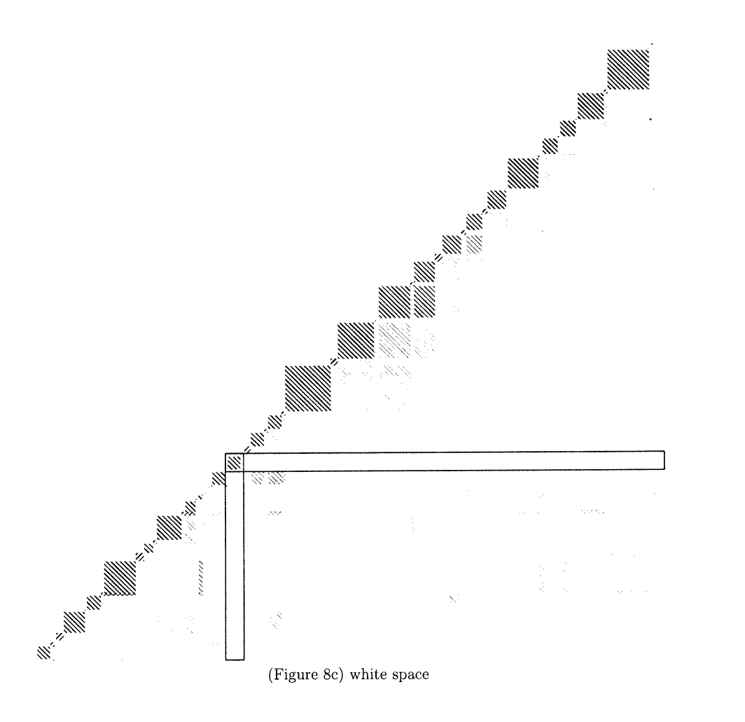

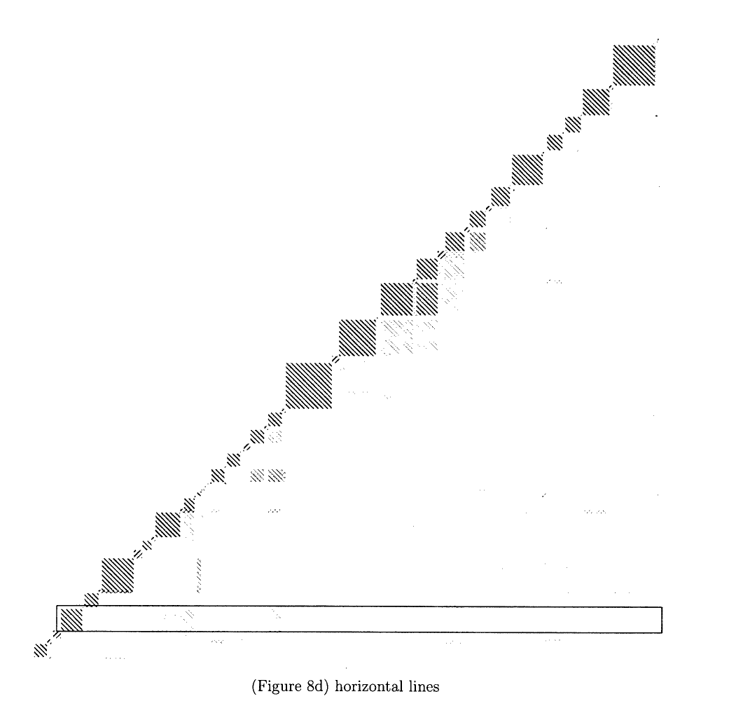

FIG. 8 shows unannotated and annotated versions of a conceptual recurrence plot representing the conversation between Andrew Denton and Peter Singer. Singer is indicated in blue or downward-right diagonal hatching, and Denton is indicated in red or upward-right diagonal hatching. Comparisons between both Singer and Denton are coloured grey or cross-hatched. The unannotated conceptual recurrence plot is shown in FIG. 8(a), with FIGS. 8(b), (c), and (d) including annotations to highlight various aspects of the plot.

For this particular example, many features can be observed. Non-uniform texturing outward from the diagonal is observed in the second part of the conversation (see FIG. 8b). Non-uniform texturing is understood to be due to the conversation slowly progressing through multiple different yet locally connected concepts. In one section of the interview, Denton quizzes Singer about a review he gave for a book on bestiality, then segues from this topic, using questions about personal criticism that Singer has received for his views, to get Singer to comment on his controversial views on abortion.

Smooth conceptual transition does not always occur, and this is evident by the presence of large blocks of blue or downward-right diagonal hatching adjacent to the diagonal which are not connected to neighbouring blocks. Each of these blocks corresponds to a particular section of the conversation concentrating on one or few key concepts, two such examples in the early part of the conversation being centred on ethics, and animals (as shown by the annotations in FIG. 8b). These blocks are called engagement blocks, and indicate extended discussion centred on a particular mixture of concepts.

White spaces indicate gaps (transition points) in the conversation, a feature which is of much interest to analysts of conversation as these gaps refer to natural pauses in the conversation where a topic shift can possibly occur (as shown in FIG. 8c). The white spaces in this particular conversation tend to occur when Denton or Singer make a light hearted remark, presumably in an effort to relieve tension.

The distribution of blocks are important as blocks that occur on the diagonal indicate sections of coherent (temporally connected) speech centred on common concepts, while blocks correlating off the diagonal indicate temporally disconnected sections of dialogue that are conceptually similar, or that the conversation revisited concepts that had been talked about previously. A feature of note are the dark bands of horizontal recurrence at the start of the conversation.

These bands indicate that this early part of the interview sets up many of the topics that are later discussed (see FIG. 8d). The lack of a corresponding vertical band indicates an absence of a comprehensive summary at the conclusion of the interview.

### Example 4

### Denton/Kennett Interview

### Data

A second Enough Rope interview was analysed to provide a comparison. The second interview is with former Australian politician Jeff Kennett (see http://www.abc.net.au/tv/enoughrope/transcripts/s1152967.htm). Kennett is a former Australian politician, and the spokesperson for an Australia depression awareness and assistance organisation called Beyond Blue. This particular interview was chosen due to Denton's commenting post-interview about how difficult the interview had been. In this interview, Denton indicated how he had wanted to discuss elements of Kennett's political career, whereas Kennett was only comfortable discussing his position as spokesperson for Beyond Blue. Denton tried to switch the conversation to politics early in the interview and in response Kennett became openly defensive and insisted that Denton concentrate on talking about Beyond Blue.

### Aims

The aims of this study were to:
(i) explore the usefulness of single concept recurrence plots; and,
(ii) identify differences and similarities between recurrence plots within the same genre.

### Method

The entire text transcript of the Denton-Kennett interview was used to generate the semantic model, as described above. Conceptual recurrence plots were generated using 50 key concepts, and by using each of the single concepts: depression and politics.

### Result

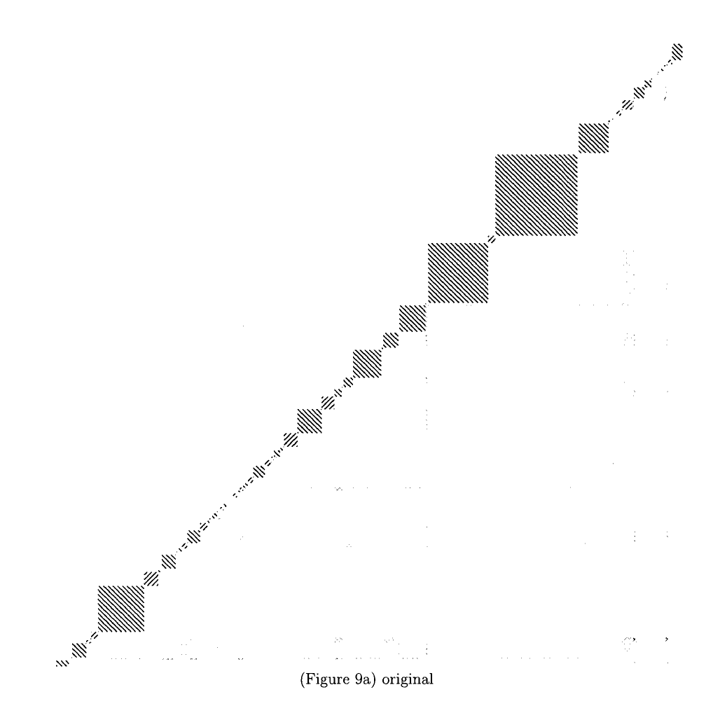

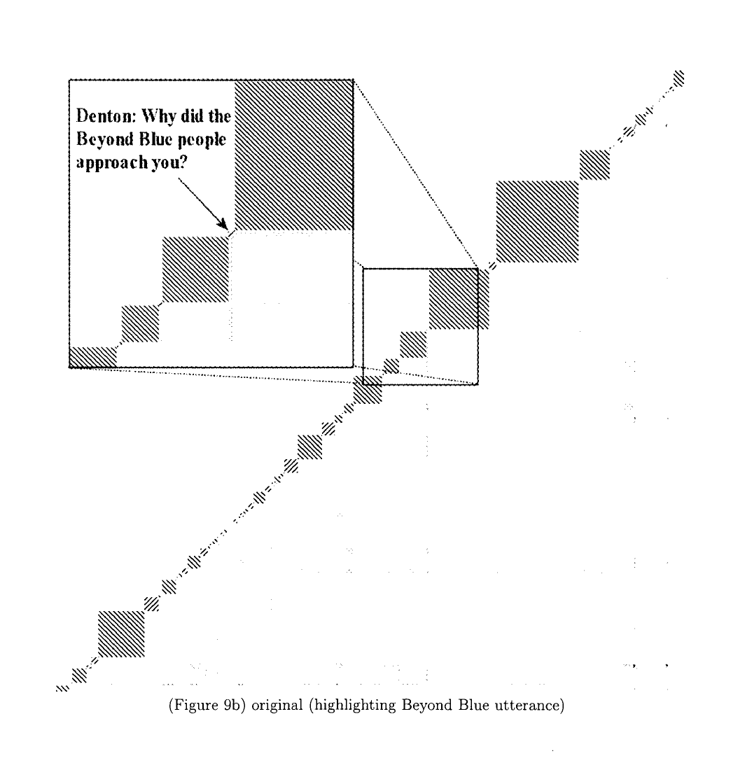

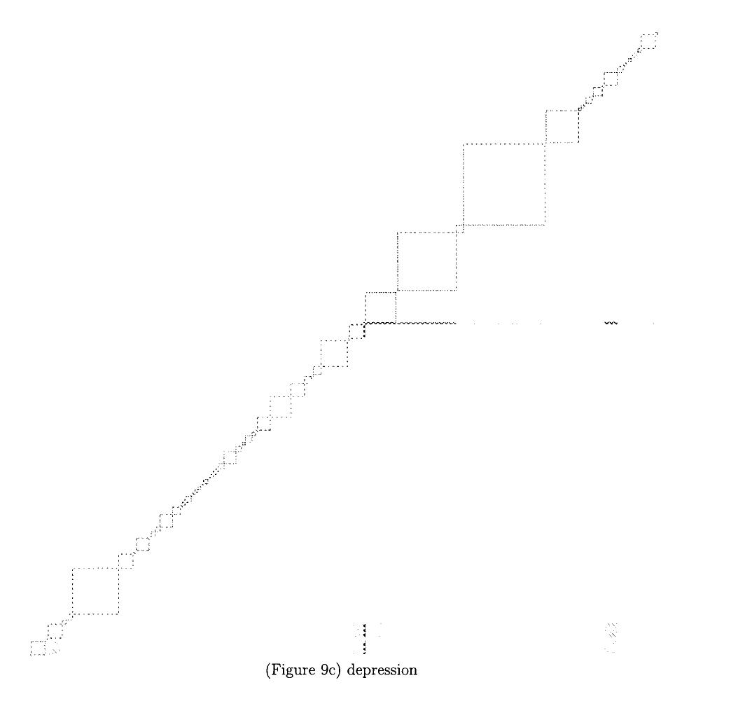

FIG. 9 highlights features of a difficult interview using conceptual recurrence plots for a conversation between Andrew Denton and Jeff Kennett on the ABC Enough Rope television program. Kennett is indicated in blue or downward-right diagonal hatching and Denton is indicated in red or upward-right diagonal hatching. Comparisons between both Kennett and Denton are coloured grey or cross-hatched. (a) The conceptual recurrence plot constructed using 30 key concepts. (b) A particular segment of recurrence is highlighted to indicate its similarity to other nearby utterances, the recurrence is due to the presence of the terms Beyond and Blue which relate to the concept of depression. (c) Conceptual recurrence plot where the concept depression is the only concept used to classify utterances. (d) Conceptual recurrence plot where the concept politics is the only concept used to classify utterances.

By contrasting the recurrence plot for the Denton/Kennett interview (FIG. 9a) and the Denton/Singer interview (FIG. 8a), it is observed that the magnitude of conceptual similarity is indeed lower. This indicates less engagement overall between conversation participants, and a lack of agreement on topics to discuss at length. No conceptual progression is observed in this interview, most likely because Kennett was somewhat defensive and elusive in answering questions about his political past, preferring to talk about the single concept of depression. This difference is visualised by constraining the utterance feature vectors (V) to the individual concepts depression (FIG. 9c) and politics (FIG. 9d), rather than using all key concepts in the calculation of utterance similarity. In these single concept recurrence plots, Kennett is observed to talk at length around the topic of depression, engaging in a long discussion around this key concept; however on the topic of politics, the amount of recurrence is severely limited. It is observed that depression was an early mentioned concept (FIG. 9c) in this interview, much like ethics was in the previous Denton/Singer interview (FIG. 8b). However, rather than using this concept to frame the remainder of the interview, Denton changed topic, which can be seen by the horizontal recurrence from these early utterances being punctuated by white space.

In FIG. 9b, one utterance is highlighted to demonstrate a feature of using conceptual similarity. This utterance is seen to recur strongly with preceding and successive utterances. The reason for this recurrence is due to the terms Beyond and Blue being strongly linked with the concept depression. The important observation here is that while none of the surrounding utterances contain the terms Beyond or Blue, they do contain terms that link to the concept of depression such as depressed, suicide and emotional. This example indicates that while the term-based similarity between two utterances may be low, the conceptual similarity can be high.

The conceptual versus term-based observation above also has implications for the use of the input text for the generation of the semantic model. If a traditional ontology was used in creating the semantic model, without using the input text, then domain specific terms such as Beyond and Blue could not have linked with the concept of depression. This conceptual connection is context specific to those who are aware of the Beyond Blue organisation. Such instances provide support for the use of the text under analysis in the building of the semantic model, either to augment an external corpus or act as the sole text input.

### Metric Primitives

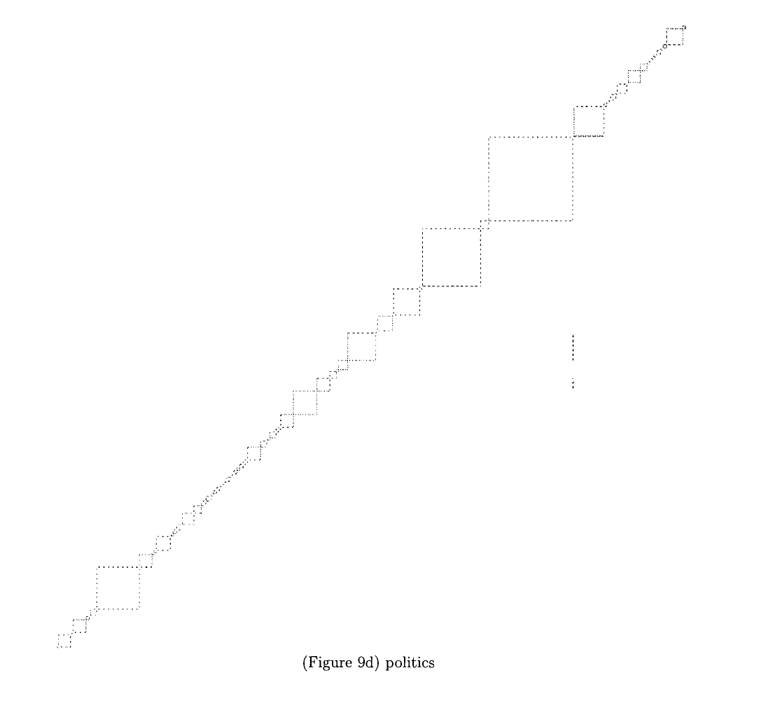

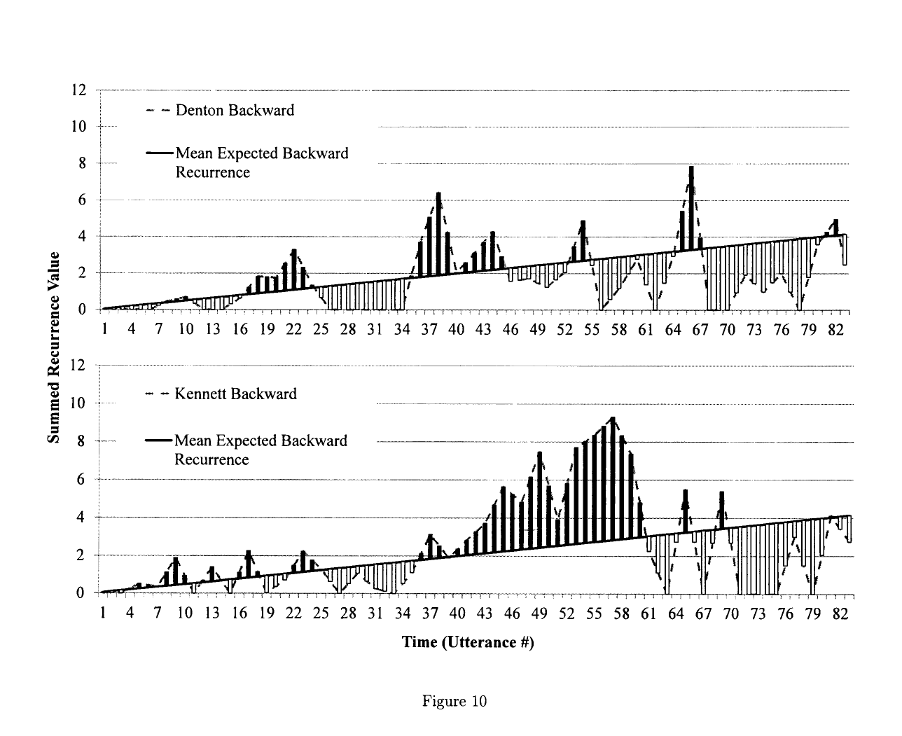

FIG. 10 includes two graphs of the long-backward-other (LBO) metric primitive representing backward recurrence during the course of the Denton-Kennett interview, for utterances by Denton (upper graph) and Kennett (lower graph), together with mean expected backward recurrence. The mean expected recurrence is calculated by first determining the average recurrence value (sum all recurrence values and divide by the number of recurrence values). This value is then multiplied by the utterance number to provide the mean expected backward recurrence.

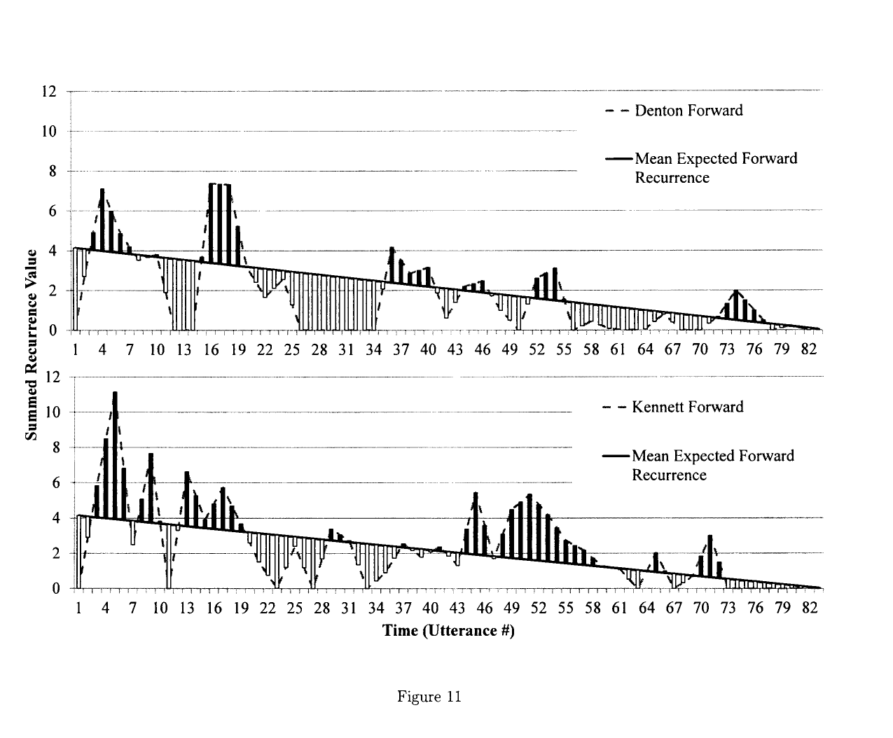

Similarly, FIG. 11 includes two graphs of the long-forward-other (LFO) metric primitive representing forward recurrence during the course of the Denton-Kennett interview, again for utterances by Denton (upper graph) and Kennett (lower graph), together with mean expected forward recurrence. The mean expected forward recurrence is obtained by first calculating the average recurrence value as above. The mean expected forward recurrence is calculated by subtracting the product of the utterance number and average recurrence from the product of the average recurrence and the number of utterances.

By separating the individuals, it is possible to observe how the deviation from the expected recurrence sum is different for each participant, particularly how Kennett has a large period of backward recurrence after utterance 37.

FIGS. 10 and 11 indicate that the Enough Rope Denton/Kennett conversation is characterised by 4 distinct periods:
(i) Period 1 (t=1−>19): Initial greeting by Denton. Kennett outlines how he wants to talk about his role with the depression awareness group Beyond Blue, with four key statements indicating this conceptual position. These four statements can be observed as peaks of high forward recurrence by Kennett in FIG. 11.
(ii) Period 2 (t=20−>37): Denton tries, unsuccessfully, to get Kennett to talk about his private life. Kennett's responses are short and mention very few concepts that are mentioned elsewhere in the conversation. Denton's low forward recurrence in this section (FIG. 2b) indicate that he doesn't repeat these questions later in the interview, however at the end of the period his backward recurrence rises (FIG. 10) likely due to him including depression related concepts in his questions. This observation supports earlier qualitative observations that Denton returns the discussion to the topic of depression at the end of this time period.
(iii) Period 3 (t=38−>60): Kennett's high backward recurrence (FIG. 10) for this period is due to the focus of the interview returning to the concept of depression. It is known from a post-interview analysis by Denton that Kennett was most content talking about depression and his higher than average recurrence for this period of time supports this observation.
(iv) Period 4 (t=61−>83): At the beginning of this period Denton asks Kennett a series of questions about his political career. Kennett's responses turn back to his role with the depression awareness group Beyond Blue and many of these utterances can be seen as having higher than average backward recurrence (FIG. 10) The lack of backward recurrence for the rest of the period indicates that Kennett does not reflect on previous content in answering some of these questions. This period of the interview is mostly closing remarks and a last chance effort by Denton to get Kennett to talk openly about his personal and political life, consequently the total forward and backward recurrence for both participants is lower than average.

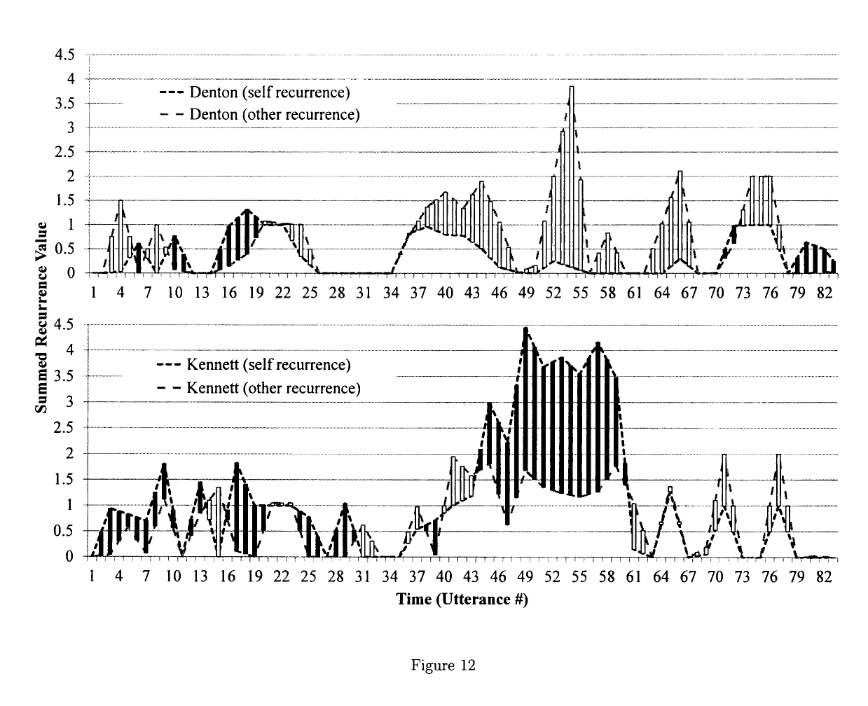

FIG. 12 shows the summed medium time scale recurrence for each conversation participant at different time points of a conversation. This graph shows the summed recurrence over a time scale of 10 utterances from the current utterance forward and backward for both Denton and Kennett in the Denton/Kennett conversation. For each graph, the recurrence is shown as two separate series, one capturing self-recurrence (MBS+MFS) and the other capturing recurrence between the two participant's utterances (MBO+MFO). These medium time scale recurrence sums are thus able to capture the interviewee/interviewer relationship of the Denton/Kennett conversation. The drop lines indicate how Denton's utterances are on average more recurrent with Kennett's utterances, while Kennett's utterances tend to recur mostly with his own. This observation suggests that Denton spends more time accommodating Kennett's utterances and that Kennett has a strong self-monologue.

### Examples

### Quantitative Analysis using Communication Metrics

In this section, the recurrence-based behavioural metrics are demonstrated on a series of multiple participant conversations. These metrics enable practitioners to understand the structure, information content, and inter-speaker relationships that are present within input data. Although not demonstrated here, the metrics could enable both real-time monitoring and post-hoc analysis of human communication from many sources, including: web forums, email, command and control situations, planning meetings, negotiations and training scenarios. An important use of these metrics is to identify characteristic behaviours of state metrics which provide sensitive early warning of important state changes by the system being monitored.

### Example 5

### Time Series of Metrics

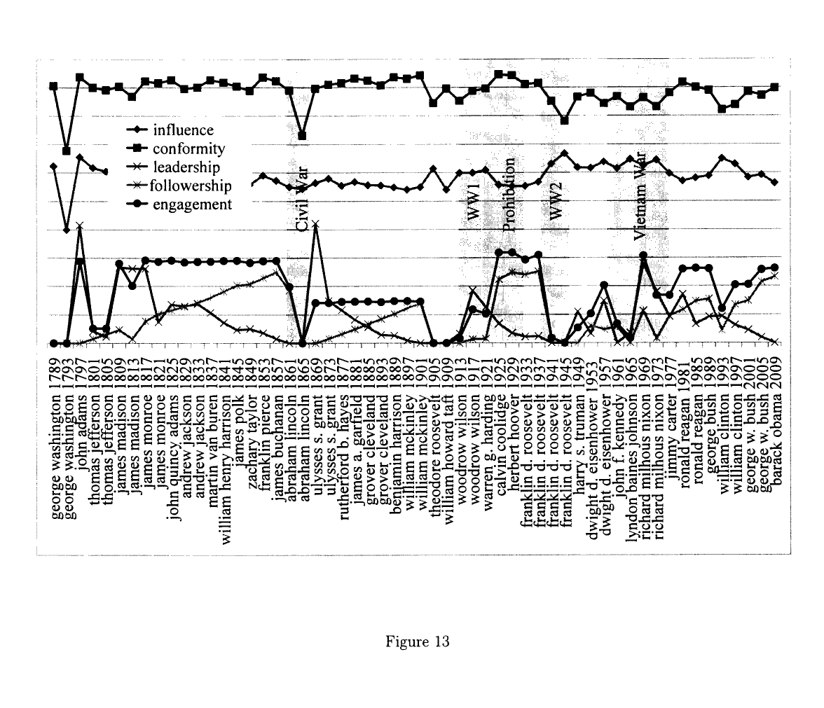

A dataset of every US Presidential inauguration speech was compiled and tested using the recurrence plotting technique. The results of the application of the recurrence metrics is shown in FIG. 13. This dataset was used to investigate the correlation between real world events that may have inspired choices of language and specific concepts used in the speech at the time, to points in the series. Features of note are the correlation of spikes in leadership near major world and domestic events (Civil War, WW1, Prohibition WW2, Vietnam War).

### Example 6

### Comparison of Participant Behaviour in a Knowledge Transfer Situation

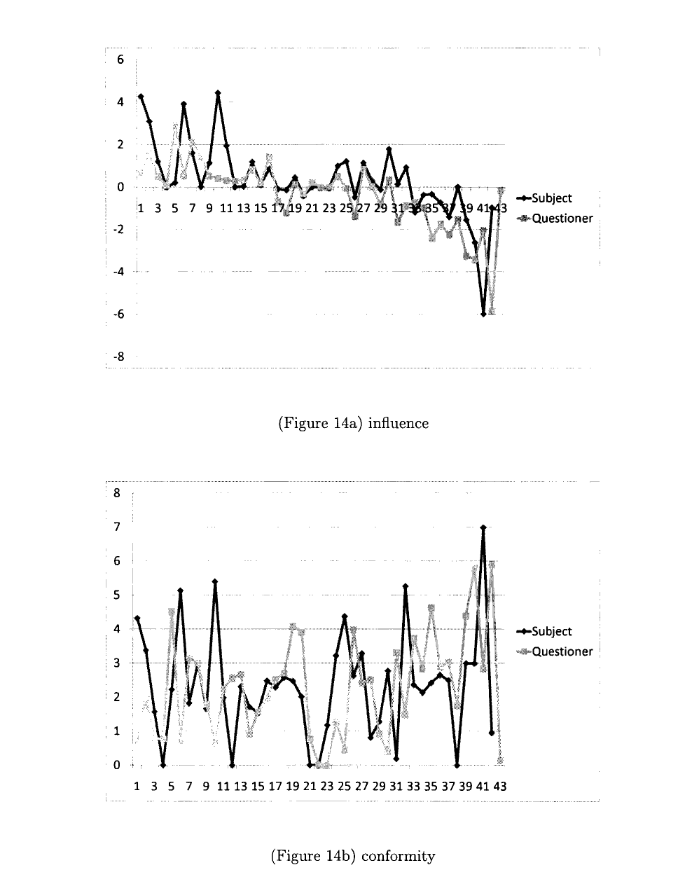

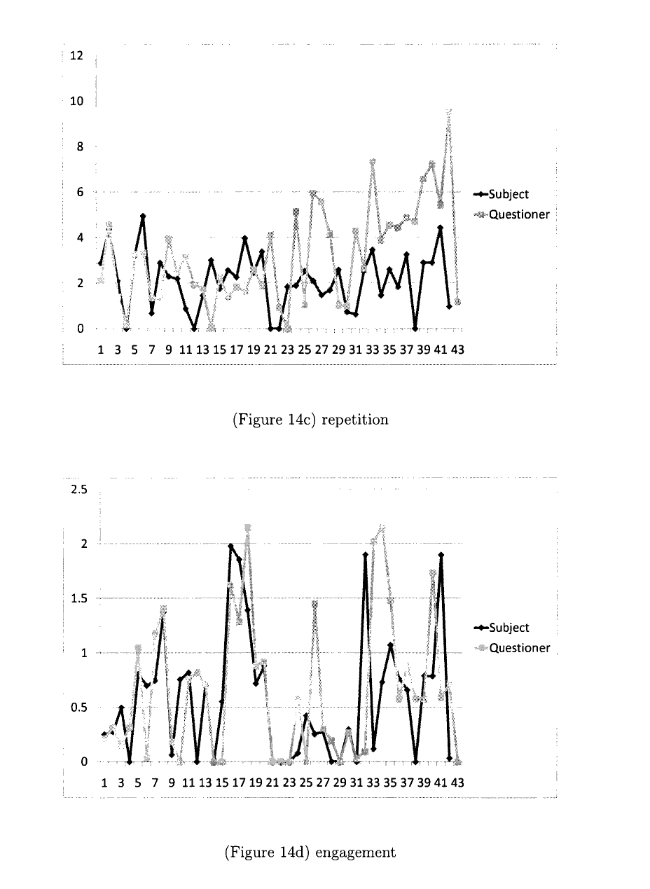

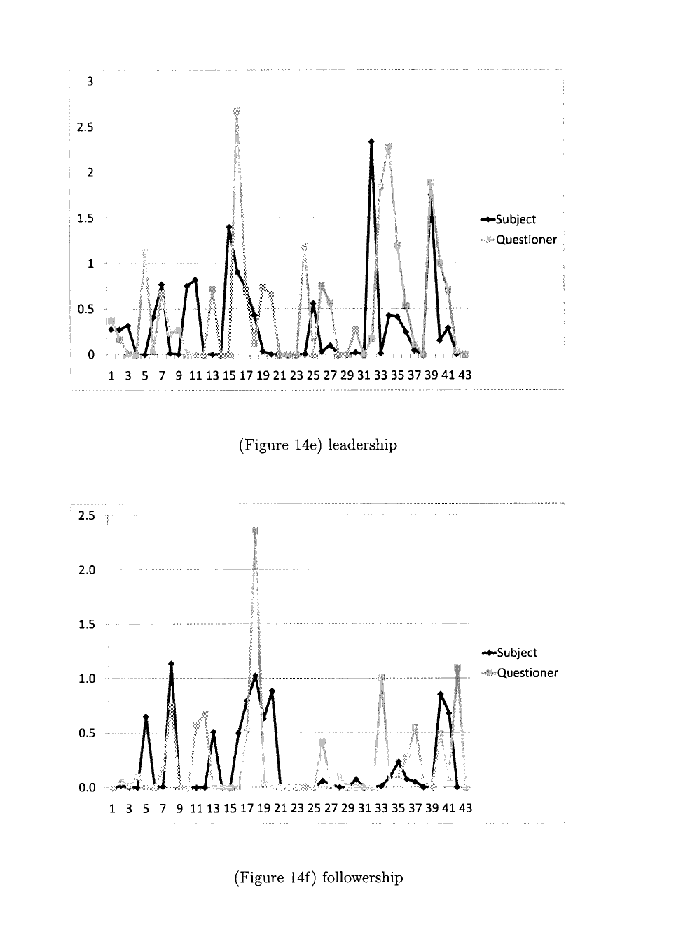

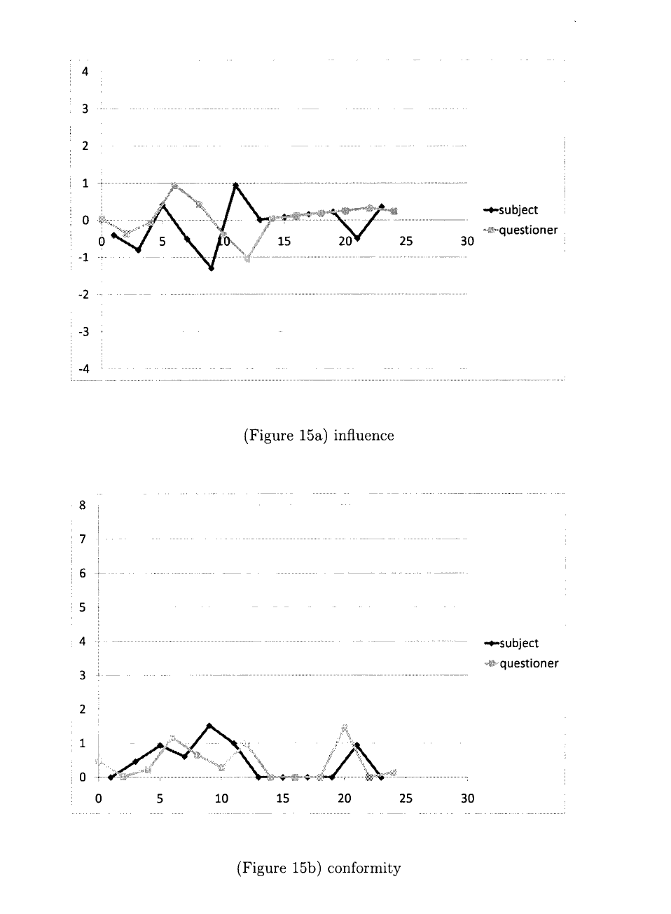

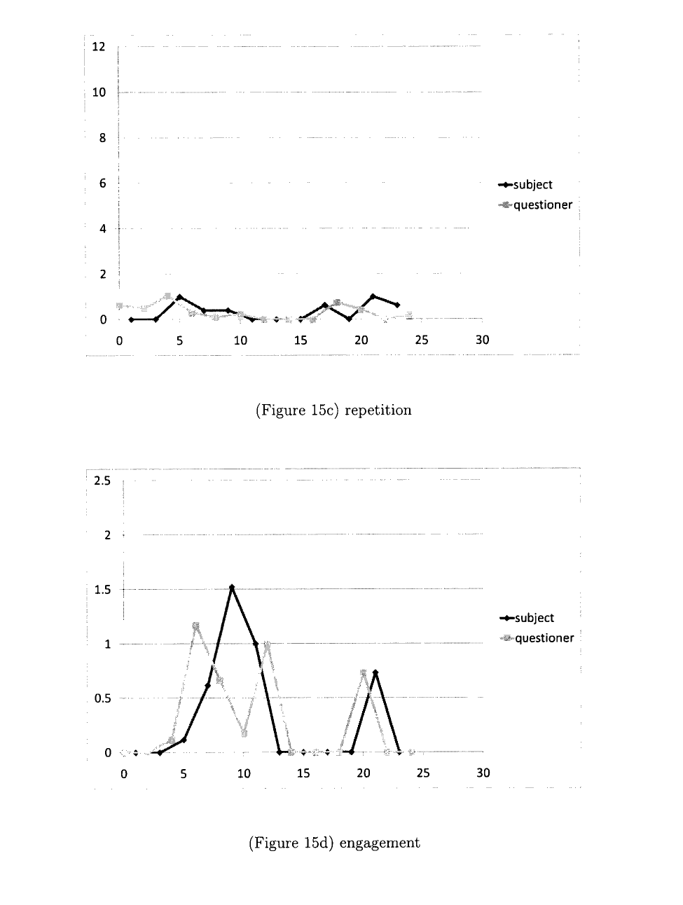

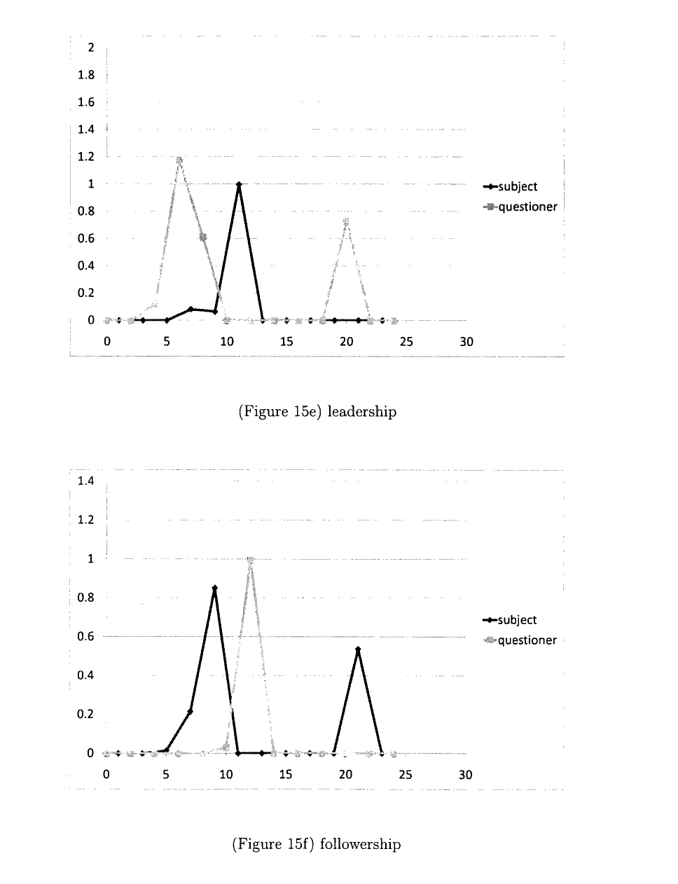

Two professional interviews, graded based on the outcome of the interview (good and poor) are included here. Both interviews begin with a participant being given an opportunity to outline their background and experience. This background was then used as the basis for a series of questions from the interviewer. If the interviewee failed to provide sufficient background, then knowledge transfer between the participants was limited, a poor outcome. Differences in behaviour between good and bad interviews can be seen by the interplay between the interviewer and the respondent in FIG. 14 and in FIG. 15.

FIGS. 14 and 15 show, for the good and bad interview transcripts, respectively, values determined by the communications analysis process for the six communication metrics for influence, conformity, repetition, engagement, leadership, and followership. In each case, the subject's utterances are shown in grey, and the interviewers utterances are shown in black.

In the good interview, participants alternate spending time leading and following the conversation, and the interviewer can be seen to increase the amount of repetition towards the end of the conversation. This increase in repetition is typical of summarisation behaviour.

In the poorly graded interview, features of note are the low values for conformity, influence and repetition when contrasted against the good interview of FIG. 14. Note also that the participants show limited leadership.

### Example 7

### Score Cards and Influence Maps

A transcript of communications on board and on the ground from the famous United Airlines flight 232 was analysed by the communications analysis system. On Jul. 19, 1989, a Douglas DC10 suffered an uncontained failure of its number 2 engine. The actions of the crew and a DC-10 instructor pilot (jump-seat training pilot) who happened to be travelling on this flight at the time are credited with reducing the total number of casualties following a crash landing. This example is a good example of communication management in a critical situation.

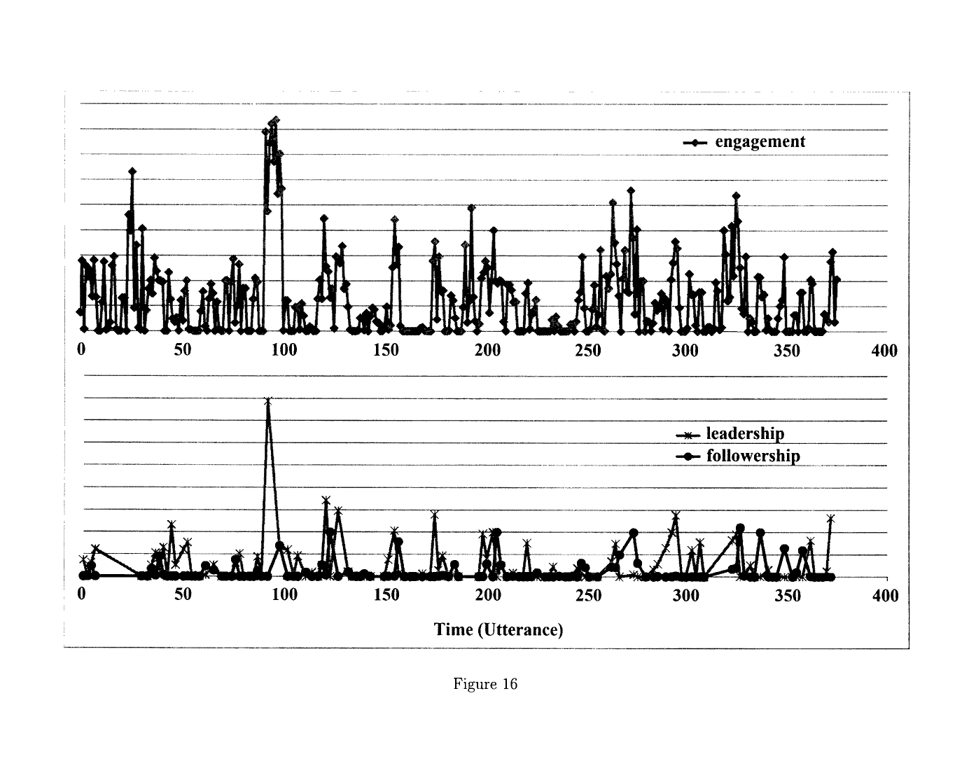

FIG. 16 includes graphs of global engagement (engagement values for each individual utterance; upper graph), as well as the captain's leadership and followership scores for his individual utterances (lower graph). The leadership values of the captain are shown to increase sharply immediately prior to many of the large engagement blocks, while his followership increases immediately following these periods of strong leadership. These patterns suggest that the captain is involved in interactions that involve both raising issues and actively listening to responses prior to leading again (Leader-Follower-Leader, LFL pattern). The graphs illustrate the effective use of time by the crew as they are engaging in productive communication most of the time, as well as the role of the captain in these periods of engagement.

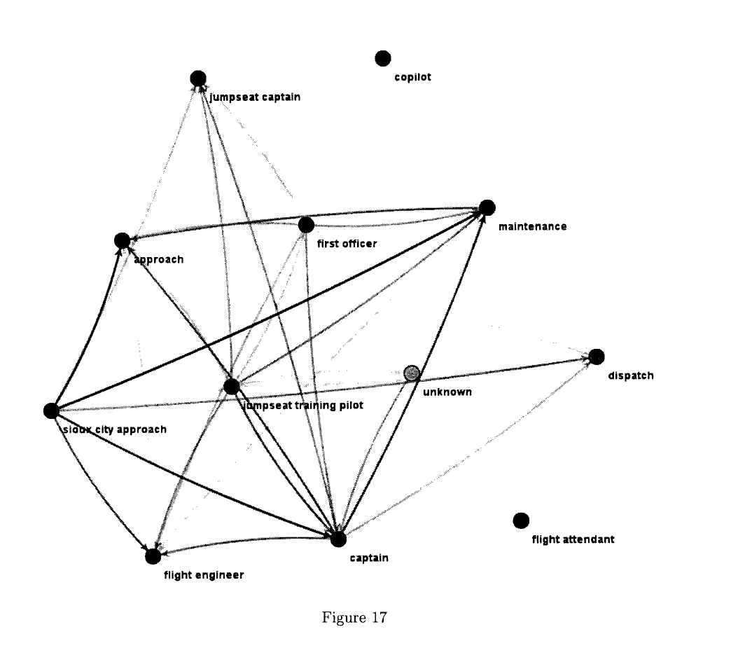

The influence scores for each participant were determined and used to generate an influence graph, as shown in FIG. 17, that connects each participant according to their influence within the conversation. This influence map shows a strong connection between two participants if one participant repeats conceptual content that is similar to conceptual content expressed by another participant at an earlier point in a conversation. The direction of the link implies which participant mentioned a concept (or group of concepts) first.

Incoming links imply that the participant at the incoming node has repeated conceptual content mentioned by the participant at the outgoing node; specific examples are that “maintenance” has been influenced by “sioux city approach”, possibly because they ask for information about key systems and technical readouts from the aircraft's gauges. Lighter links imply less influence, and dark links imply more influence.

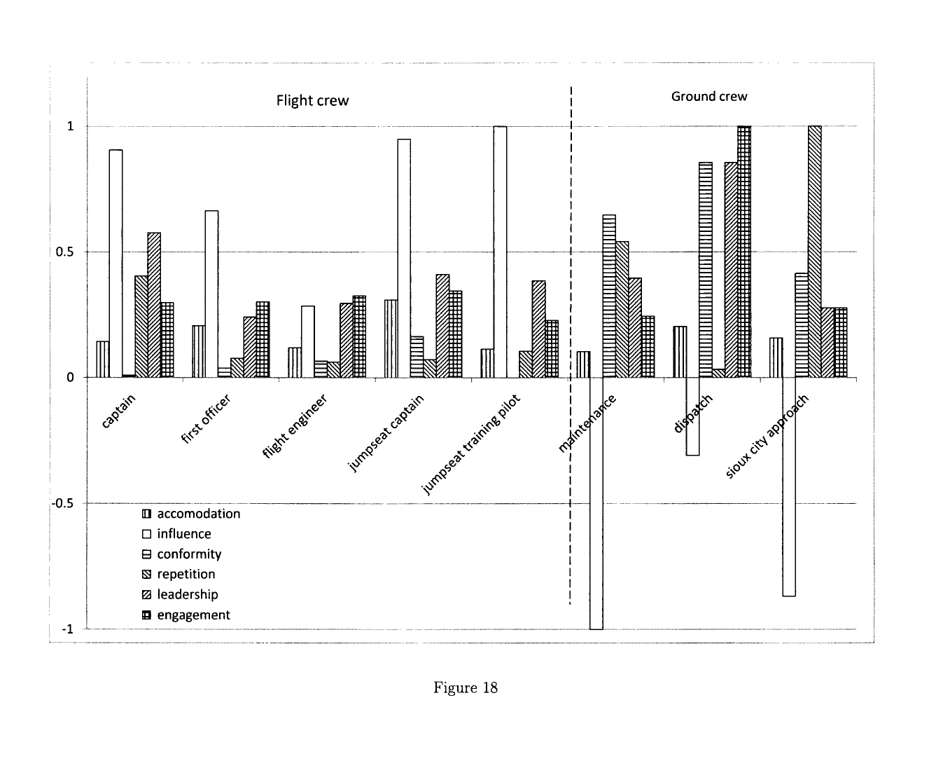

FIG. 18 shows summed totals for each of 6 metrics for each participant for the transcript. Not surprisingly, the Captain and Jump-seat Training Pilot both show strong leadership and engagement.

The communications analysis processes described herein are scalable. In general, the range of text input is likely to vary from several sentences to hundreds of pages of text. The processes described herein are able to deal with a range of requirements related to the size of the input and give consistent results regardless of the size of the input text. In terms of computational performance, due care was taken to ensure that the efficiency of the processes scales well with the input.

Many modifications will be apparent to those skilled in the art without departing from the scope of the present invention.

1. A communications analysis process, including:
accessing communications data representing communications of one or more persons;
processing the communications data to determine similarity data representing similarities between concepts expressed by the one or more persons at different times during said communications; and
processing the similarity data to determine one or more metrics of said communications.

2. The process of claim 1, wherein the metrics include metrics for each of one or more selected utterances of said communications.

3. The process of claim 1, wherein the processing of the communications data includes:
identifying subsets of said communications as utterances of said one or more persons;
identifying terms of said utterances as representing conceptual content of said communications expressed by said one or more persons;
selecting a subset of said terms as key terms representing respective concepts;
generating numeric measures of the conceptual similarities of the unselected terms to said key terms; and
for each of said utterances, generating a corresponding feature vector including the generated numeric measures of the terms included in the utterance to enable a similarity of any two of said utterances to be determined from the feature vectors for those two utterances.

4. The process of claim 1, wherein the metrics include a contribution metric representing the number of concepts of an utterance.

5. The process of claim 4, wherein the contribution metric is generated by summing concept scores for the utterance, said concept scores representing similarities of terms in the utterance to said concepts.

6. The process of claim 4, wherein the contribution metric is generated by summing the products of concept scores and transfer functions for the utterance, said concept scores representing similarities of terms in the utterance to said concepts.

7. The process of claim 1, wherein the metrics include an ownership metric representing the degree to which a person owns the content of an utterance.

8. The process of claim 7, wherein the ownership metric is generated by subtracting the similarity of the person's utterance and the previous utterance from the similarity of the person's utterance with itself.

9. The process of claim 1, wherein the metrics include an accommodation metric representing the degree to which a speaking person accommodates the immediately previous speaking person's utterance.

10. The process of claim 9, wherein the accommodation metric is generated as the similarity of the person's utterance and the previous speaker's utterance.

11. The process of claim 1, wherein the metrics include a leadership metric representing the degree to which a speaking person expressed a new concept that was subsequently repeated by one or more other persons.

12. The process of claim 11, wherein the leadership metric for an utterance of a person is generated by summing similarities of the utterance to one or more successive utterances by one or more other persons.

13. The process of claim 11, wherein the leadership metric for an utterance of a person is generated by summing similarities of the utterance to one or more successive utterances by one or more other persons, and then multiplying the sum by an ownership metric for the utterance.

14. The process of claim 1, wherein the metrics include a followership metric representing the degree to which a speaking person repeats the concepts expressed in preceding utterances by one or more other persons.

15. The process of claim 14, wherein the followership metric for an utterance is determined by summing the similarities of the utterance with every one or more preceding utterances by other people within a range of utterances from said utterance.

16. The process of claim 14, wherein the followership metric for an utterance is determined by summing the similarities of the utterance with every one or more preceding utterances by other people within a range of utterances from said utterance, and then multiplying the sum by an accommodation metric for the utterance.

17. The process of claim 1, wherein the metrics include an engagement metric representing how well the current utterance engages with concepts suggested by other speakers.

18. The process of claim 17, wherein the engagement metric for an utterance is determined by summing the similarities of every preceding and successive utterance by other people within a specified range of utterances from the utterance.

19. The process of claim 1, wherein the metrics include a fixation metric representing the degree to which a person repeats concepts.

20. The process of claim 19, wherein the fixation metric for an utterance is generated by summing the similarities of the utterance with every preceding and successive utterance by the same person within a specified range of utterances from the utterance.

21. The process of claim 1, wherein the metrics include an influence metric representing the degree to which the utterance introduces new concepts that are repeated in the future.

22. The process of claim 21, wherein the influence metric for an utterance is determined by summing the similarities of the utterance with every preceding utterance by a different person and subtracting this sum from the summed similarities of the utterance with every subsequent utterance by a different person within a specified range of utterances from the utterance.

23. The process of claim 1, wherein the metrics include a conformity metric representing the degree to which an utterance repeats previously and subsequently expressed concepts.

24. The process of claim 23, wherein the conformity metric is determined by summing the similarities of the utterance with every preceding and subsequent utterance by a different person within a specified range of utterances from the utterance.

25. The process of claim 1, wherein the metrics include a repetition metric representing the degree to which a person repeats their own concepts.

26. The process of claim 25, wherein the repetition metric is determined by summing the similarities of the utterance with every preceding and subsequent utterance by the same person within a specified range of utterances from the utterance.

27. The process of claim 1, including generating values of a plurality of metric primitives for each of said utterances of a corresponding person by summing the similarities of the utterance with one or more selected others of said utterances, said others for each of said metric primitives being selected as a corresponding unique combination of values specifying: (i) the range of utterances from the utterance within which other utterances can be selected; (ii) whether only other utterances following or only other utterances preceding the utterance can be selected; and (iii) whether only the person's own utterances can be selected or only utterances by others can be selected.

28. The process of claim 27, including generating behavioural metrics for one or more of said utterances by combining values of selected ones of the metric primitives.

29. The process of claim 27, including:
generating normalised values of said metric primitives; and
generating behavioural metrics for one or more of said utterances by combining values of selected ones of the normalised metric primitives.

30. The process of claim 1, including generating concept recurrence data representing a visual representation of said similarities during said human communications, including a chart with two axes representing utterances, and the similarity between any two utterances being represented visually at corresponding coordinates.

31. The process of claim 30, wherein the similarity between any two utterances is represented visually by colour and/or shading.

32. The process of claim 30, wherein each utterance is represented by a corresponding dimension representative of the length of the utterance.

33. A computer-readable storage medium having stored thereon programming instructions configured to cause at least one processor executing the stored programming instructions to execute the process of claim 1.

34. A communications analysis system configured to execute the process of claim 1.

35. A communications analysis system, including one or more communications analysis components configured to:
access communications data representing communications of one or more persons;
process the communications data to determine similarity data representing similarities between concepts expressed by the one or more persons at different times during said communications; and
process the similarity data to determine one or more metrics of said communications.
